(19) United States
(12) Patent Application Publication
(10) Pub. No.: US 2011/0238755 A1
(43) Pub. Date: Sep. 29, 2011

(54) PROXIMITY-BASED SOCIAL NETWORKING

(76) Inventors: Hameed Khan, East Haven, CT (US); Umair Aziz, Karachi (PK)

(21) Appl. No.: 13/071,289

(22) Filed: Mar. 24, 2011

Related U.S. Application Data
(60) Provisional application No. 61/317,165, filed on Mar. 24, 2010.
(60) Provisional application No. 61/317,615, filed on Mar. 25, 2010.
(60) Provisional application No. 61/318,678, filed on Mar. 29, 2010.
(60) Provisional application No. 61/348,098, filed on May 25, 2010.

(51) Int. Cl. G06F 15/16

(52) U.S. Cl. 709/204

(57) ABSTRACT

Various embodiments facilitate proximity-based social networking. In one embodiment, a Proximity-based Social Networking facilitator system (“PSN”) determines and provides a user with relevant information based on his proximity to other users of his social and other networks. Proximity determinations may be based on various factors, including user location, user affinity, user activities, and the like. In one embodiment, the PSN determines a group of users that are proximately located to one another, and provides users of the group with information about other users without disclosing their actual location on a map. The users of the group receive the information via mobile computing devices, and can use the mobile computing devices to further interact with the other users of the group, such as by arranging meetings, communicating, and/or engaging in transactions.

### TECHNICAL FIELD

The present disclosure relates to methods, techniques, and systems for proximity-based interactions and, in particular, to methods, techniques, and systems for facilitating proximity-based social networking.

### BRIEF DESCRIPTION OF THE DRAWINGS

FIG. 1A illustrates an example block diagram of an example embodiment of a proximity-based social networking facilitator system.

FIG. 1B illustrates operation of an example embodiment of a proximity-based social networking facilitator system with respect to an example user community.

FIG. 2A is an example flow diagram of an example proximity-based social networking facilitator process performed by an example embodiment.

FIG. 2B is an example flow diagram of an example proximity-based social networking client process performed by an example embodiment.

FIGS. 3A-3U illustrate example client device screen displays provided by an example embodiment of a proximity-based social networking facilitator system.

FIG. 4 is an example flow diagram of an identity aggregator process performed by an example embodiment of a proximity-based social networking facilitator system.

FIG. 5 is an example flow diagram of a feed aggregator process performed by an example embodiment of a proximity-based social networking facilitator system.

FIG. 6 is an example block diagram illustrating example transactions facilitated by an example embodiment of a proximity-based social networking facilitator system.

FIG. 7 is an example flow diagram of a transaction facilitator process performed by an example embodiment of a proximity-based social networking facilitator system.

FIG. 8 is an example block diagram of an example computing system for implementing an example proximity-based social networking facilitator system according to an example embodiment.

FIG. 9 is an example block diagram of an example mobile computing device for implementing an example proximity-based social networking client according to an example embodiment.

### DETAILED DESCRIPTION

The headings employed herein are used to assist in the presentation and organization of the material and are not to be used to limit the scope of the described techniques.

### 1. Overview

Embodiments described herein provide enhanced computer- and network-based methods, systems, and techniques for providing users with relevant information and facilitating interactions based on proximity and social affinity. Example embodiments provide a Proximity-Based Social Networking Facilitator System (“PSN”), which enables users to engage in new decisions, behaviors and actions based on proximity and social affinity. In some embodiments, the PSN determines and provides a user with relevant information based on his proximity to other users of his social network(s), while respecting and maintaining privacy of a user's exact physical or virtual location. Proximity can be based on various factors, including a user's location (e.g., latitude/longitude) in physical space with respect to the location of another user, geographic/topographic factors (e.g., the presence of rivers, hills, or other barriers to travel), topological factors (e.g., the connectedness of a city or other area according to roads, sidewalks, etc.), a user's virtual location (e.g., in a chat room), and the like. Determining relevant information may further be based on a user's affinity for other users, places (e.g., restaurants, clubs, stores, cities, parks), things (e.g., books, music, goods, foods), activities (e.g., sports, hobbies), or the like. Affinity for other users can be measured or otherwise determined based on a user's social network. In one embodiment, the PSN can aggregate multiple social networks of which a user may be a member, so as to provide a unified view of a user's relationships with others, as well as universal communication mechanisms (e.g., chat across multiple messaging services, propagating status updates to multiple social networks, etc.).

In the world of Internet applications, location is currently defined only in terms of a single dimension, namely latitude and longitude. The techniques described herein shift the existing paradigm of location to a new paradigm of proximity, by considering multiple dimensions such as place, time, order, occurrence, or affinity relative to people, objects, or locations. Thus, the concept of proximity is not limited merely to spatial characteristics/dimensions or absolute location, but also includes measures of closeness or nearness based on relationships and/or interactions between users and other people, places, or things.

The PSN can use proximity in various ways and for various functions. In some embodiments, the PSN includes, provides, or implements techniques based on or related to various facets of proximity, including geographic proximity, such as a measure of geographic closeness, possibly based on topographic and/or topological features; social proximity, such as a measure of social closeness between two or more persons, possibly as measured with respect to a social network or other type of relationship graph; probable proximity, such as a measure of a likelihood that a person is at or near a particular location; predictive proximity, such as determining the probable location of a person based on calendars, history, and other information; and the like.

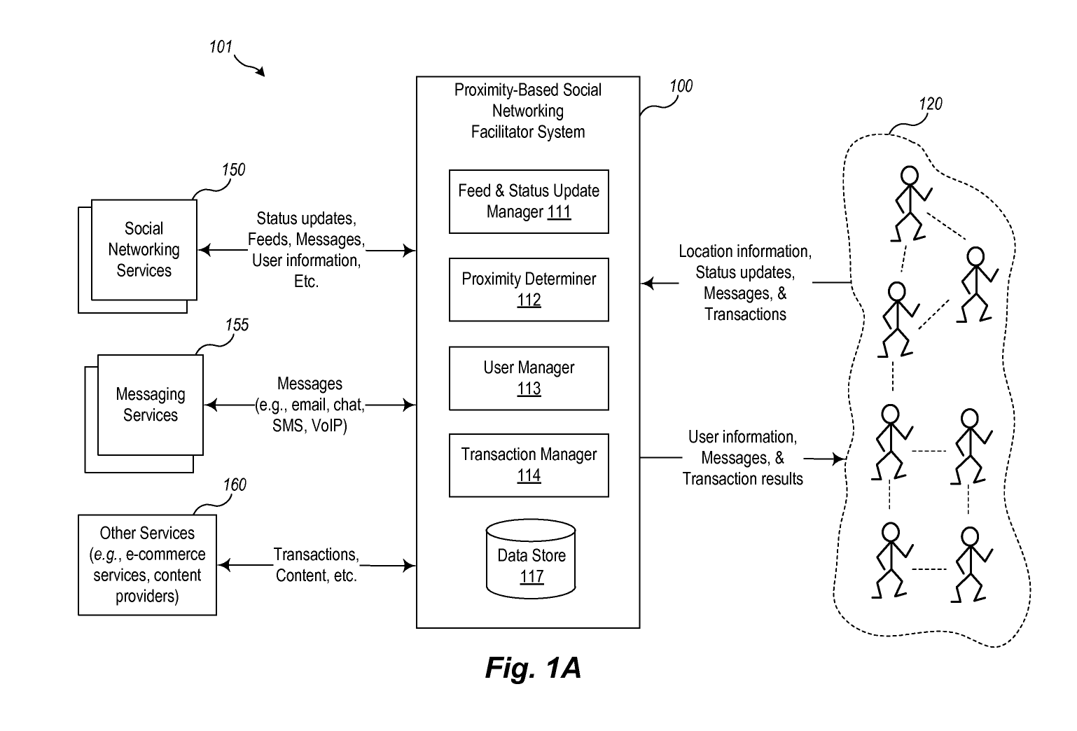

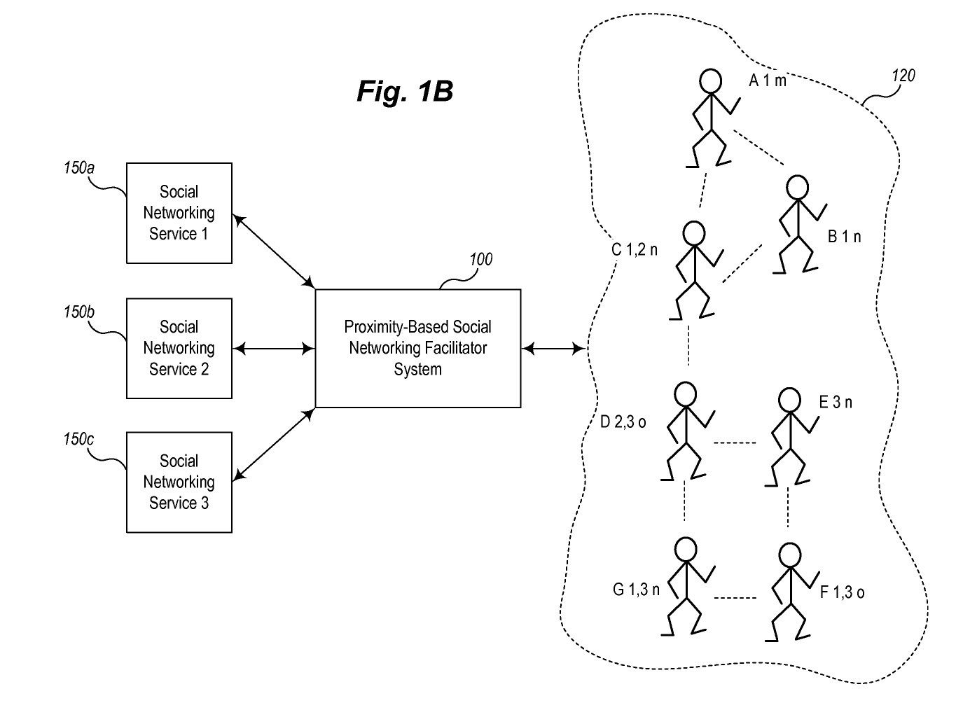

FIG. 1A illustrates an example block diagram of an example embodiment of a proximity-based social networking facilitator system. In the illustrated example embodiment, a PSN 100 comprises one or more functional components/modules that cooperate to provide a proximity-based social networking environment 101 for multiple users who each engage in or otherwise belong to one or more social networks. In this embodiment, the PSN 100 includes a feed and status update manager 111, a proximity determiner 112, a user manager 113, a transaction manager 114, and a data store 117. The PSN 100 provides proximity-based social networking services to a user community 120 by interacting with one or more social networking services 150, one or more messaging services 155, and one or more other services 160 (e.g., e-commerce services, content providers).

The proximity determiner 112 receives location information (e.g., GPS coordinates) from client devices operated by users of the user community 120. The proximity determiner 112 then determines groups or sets of users that are in proximity to one another. For example, the proximity determiner 112 may determine that two users are in proximity to one another if they are within a reasonable walking distance (e.g., 500 meters) of one another. As noted, other location-based factors may be taken into account, including geographic factors, such as terrain features, elevation, and the like. Furthermore, non-location-based factors may also be taken into account. For example, the proximity determiner 112 may consider crime statistics associated with a particular geographic area when making a judgment about how “close” two users are to one another, based on the intuition that a user may be less willing to travel through a high-crime area. As another example, the proximity determiner 112 may consider a user's actual or predicted affinity for a particular geographic area, based on the intuition that a user may be more willing to travel into or through an area that holds a particular attraction for the user, for example because the user likes shops, restaurants, or other users that are situated in the area.

The feed and status update manager 111 receives feeds, status updates, and other information from the one or more social networking services 150 and/or other services 160. The feed and status update manager 111 aggregates the received information based on factors including user proximity and user affinity. For example, the feed and status update manager 111 may order items (e.g., status updates) based on how close a user is to another user in their social network, how often a user has interacted or communicated with another user, and the like. The feed and status update manager 111 then transmits the aggregated information to the client devices operated by the users.

The feed and status update manager 111 also facilitates various universal or cross-network communication techniques, including the ability to receive a single status update from a user and forwarding that status update to all social networking services 150 used by that user. Also, the feed and status update manager 111 (or some other component, such as a communication proxy) enables chat, messaging, and/or voice communication across multiple heterogeneous devices, social networks, messaging services, and the like.

The transaction manager 114 facilitates proximity-based transactions between users and merchants (or other users). For example, a merchant may provide a transaction opportunity that is associated with a particular place, time, and/or user (or class of users). When a user is determined to be proximately located to the transaction opportunity, the transaction manager 114 notifies the user of the opportunity. If the user wishes to engage in the opportunity, the transaction manager 114 facilitates the corresponding transaction, such as by initiating a payment to the merchant.

FIG. 1B illustrates operation of an example embodiment of a proximity-based social networking facilitator system with respect to an example user community. In particular, FIG. 1B shows operation of the PSN 100 with respect to users of the user community 120 and the social networking services 150.

The PSN 100 is configured to determine or otherwise identify relationships that cross the boundaries of multiple social networks. Users can be members of one or more of the social networking services 150. For example, users A and B are members of social networking service 150a (service 1); user C is a member of social networking services 150a (service 1) and 150b (service 2); user D is a member of social networking services 150b (service 2) and 150c (service 3); user E is a member of service 3; and users G and F are members of services 1 and 3.

In the illustrated example, the PSN 100 can determine that user D is a friend of a friend of user A (via user C), even though users A and D do not belong to any of the same social networking services 150. As another example, the PSN can determine that user C is a friend of a friend of user E (via user D), even though users C and E do not belong to any of the same social networking services 150. In this manner, the PSN 100 can leverage and aggregate information provided and largely managed by other social networking services, such that the PSN 100 can provide functions and facilitate interactions that may not be achievable by using the social networking services in isolation from one another. These techniques can be expanded to any number of degrees of separation (e.g., three degrees, six degrees). In some embodiments, the PSN can provide a user with an indication of the number of degrees of separation between the user and some popular figure (e.g., Kevin Bacon).

The PSN 100 can filter information based on user proximity. In the illustrated example, users of the community 120 are at various geographic locations. In particular, user A is at location m; users B, C, E, and G are at location n; and users D and F are at location o. The PSN 100 can filter information based on which users are in proximity with one another. For example, the PSN 100 will inform user B that friend C is nearby, because users B and C are at or near location n. However, the PSN 100 will not provide information to user B about friend A (and vice versa), because even though A and B are friends in social network 1, they are not at or near the same location. In addition, the PSN 100 may not provide information to user B about friend A (and vice versa) because one or both of A or B has indicated that they do not want to share information with other users, as discussed further below.

By filtering information based on user proximity and other factors, the PSN 100 can provide users with information that is relevant to them at their current location and at a current point in time. As a user becomes more engaged in an online, digital environment, it is possible for the user to quickly become overwhelmed with the amount of information, or the number of connections or operations, that are available to the user. For example, a user may quickly find that he has scores of friends on a first social networking service, over a hundred friends on a second social networking service, hundreds of email addresses and/or phone numbers distributed across multiple address books (e.g., in multiple email clients, in multiple cell phones or other devices), multiple user names or instant messenger handles, and the like. By filtering information based on proximity, the PSN 100 thus provides a tool for dynamically reducing clutter and complexity by providing a user with information based on his changing location and more generally his changing proximity to real and virtual objects (e.g., people, places, things, information, etc.).

The PSN 100 enforces a combination of privacy and reciprocity rules that create a level playing field, where users engage on equal footing with one another. First, exact user locations are never revealed. Second, a user can only receive information about other proximate users if he himself makes that information available. Third, no information will be revealed about a user who elects not to participate. These features of the PSN 100, as discussed further below, create a safe, secure environment in which users can engage in proximity-based social networking.

The PSN 100 respects and enforces user privacy, particularly with respect to user location. More specifically, the PSN 100 does not disclose the exact physical location of any user. Rather, the PSN 100 only informs a user that one or more other users are in proximity (e.g., nearby). In at least one embodiment, the PSN 100 does not show, or cause to be shown, the location of users on a map or similar instrument. Then, the users in proximity to one another can decide whether they want to take the next step and arrange a face to face meeting. For example, the PSN 100 may inform user C that friend B and friend of friends E and G are nearby (because they are all at or near location n); inform user D that friend of friend F is nearby (because they are both at or near location o); and so on. These users can then exchange meeting requests to arrange face to face meetings, if they so desire. In addition, or instead, these users can engage in other activities, such as a telephone call, chat, video conference, or the like.

The PSN 100 also enforces reciprocity rules, thereby facilitating trust and security. In particular, a user cannot obtain information about other proximately located users unless the user is willing to make himself “visible” (e.g., electronically presenting information about the user's physical location; making the user's physical location electronically visible) to those other proximate users. For example, if user B elects to not make himself visible, then user B will not be provided with information about the fact that friend C is at or near the same location. Thus, a user cannot surreptitiously observe movements or locations of other users. And conversely, if a user elects to not be visible, then the PSN 100 will never make information about the location of the user visible to other users. Thus, continuing the example above, if user B elects to not make himself visible, no other users (e.g., user C who is a friend of user B) will be provided with information about the fact that user B is at or near the same location.

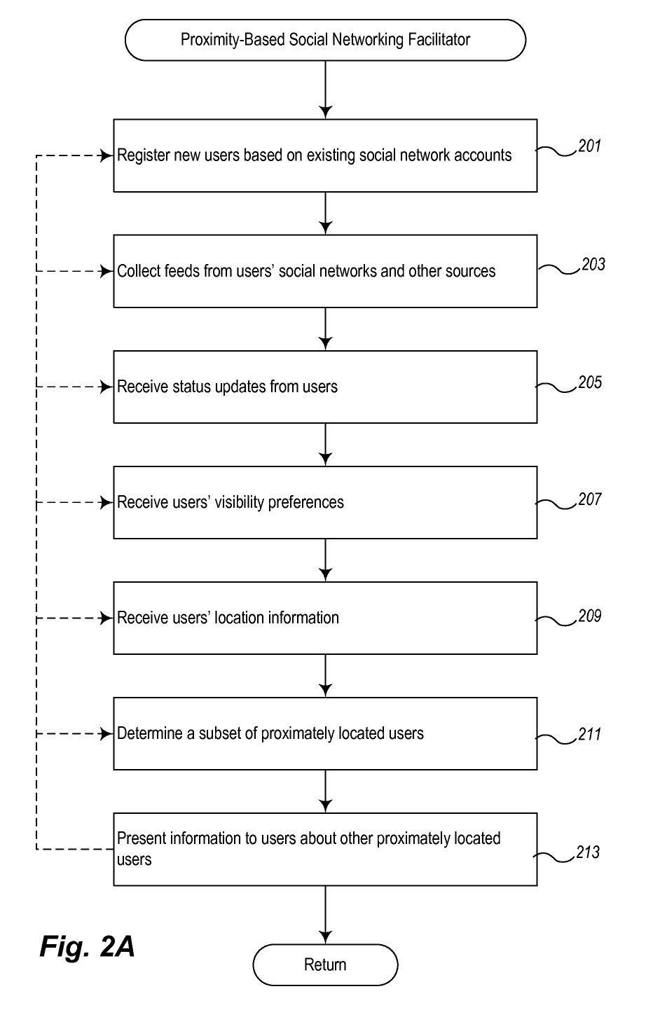

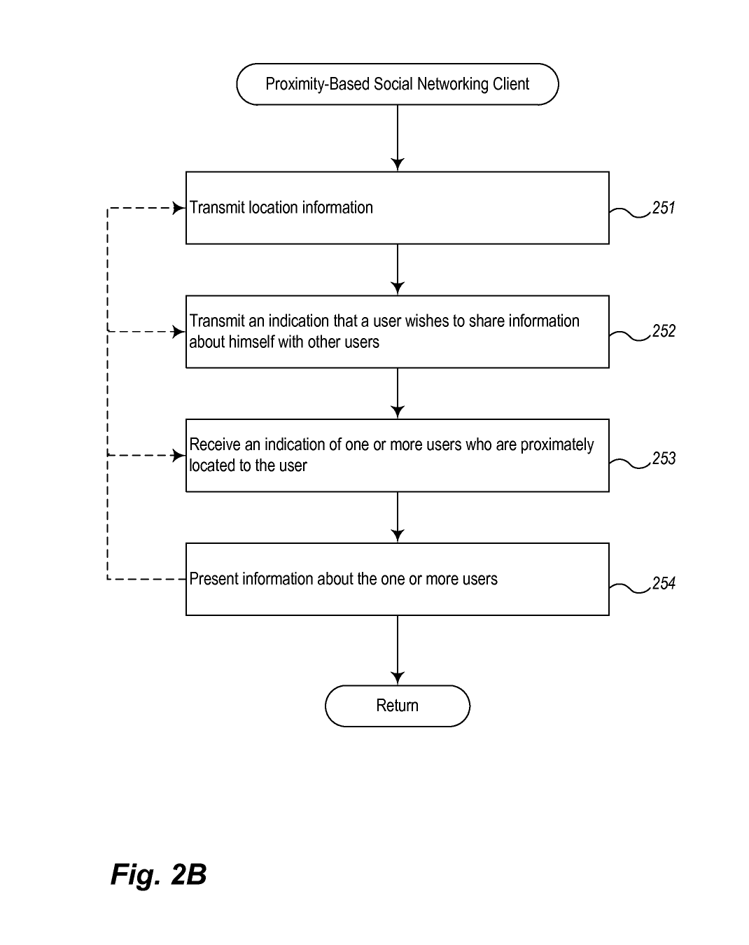

FIG. 2A is an example flow diagram of an example proximity-based social networking facilitator process performed by an example embodiment. The illustrated process may be performed by, for example, one or more blocks of the PSN 100.

The process starts at block 201, where the PSN registers one or more users based upon existing social network accounts. In an example embodiment, the users' current existing social network account registration credentials are used—there is no need to reregister for the PSN.

In block 203, the PSN aggregates output (e.g., from social networking status updates and other feeds) from one or more of the networks and/or other sources that a user is connected to and performs such aggregation for one or more users. In some embodiments, the networks may be social networks that are well established, may be community or corporate networks, or may be dynamically created groups, for example, special-purpose or singular purpose networks, such as a group of soccer parents.

In block 205, the PSN receives feed and/or status updates from users. Feeds include information about users and their activities on one or more social networks or other information systems, such as picture or video sharing sites, calendaring systems, and the like.

In block 207, the PSN receives visibility preferences for one or more users. A visibility preference includes an indication of whether or not a user wishes to be made visible to one or more other users. The user may specify in various ways to which he should be made visible. For example, a user may indicate that he wishes to be made visible only to his friends, friends of friends, or some other group (e.g., work colleagues, members of his soccer team, attendees at a convention).

In some embodiments, a user may specify a group or profile that provides for fine-grained control over visibility. For example, a user may create a social profile (e.g., including indications of casual friends), a work profile (e.g., including indications of work colleagues), an interest-based profile (e.g., including indications of friends who share a particular interest, such as soccer, a political topic, dating, theater, or the like), a location-based profile (e.g., including indications of friends who reside, work, or travel in or near the same location), or the like. The user can then become visible with respect to one or more selected profiles, such that only members of the selected profiles will obtain proximity-based information about the user.

Note that in at least some cases, the profiles need not contain explicit indications of other users. For example, fora soccer-based profile, a user may simply indicate that he has an interest in soccer (e.g., generally or for a particular team), and the profile will operate to select users who have made the same indication and/or to filter out other users who have not made the same indication.

Note also that two or more profiles may be combined, so that a user's visibility can be limited to an intersection (or union) of the sets of users associated with each of the combined profiles. Thus, for example, a user may activate a professional profile as well as a skiing profile, in order to develop his professional network by meeting other users in a same or similar field of endeavor who also have an interest in skiing. As another example, while traveling on holiday a user may activate a location-based profile (e.g., Seattle) with a dating profile, so that he can meet other users who are interested in dating and who also live in his home town, so that upon return from his travels he need not engage in a long-distance relationship.

In block 209, the PSN receives users' location information. Receiving user location information includes receiving, from a client device operated or otherwise associated with a user, some indication of the user's location, such as may be provided by a GPS system, RFID network, or other location determining system or component.

In block 211, the PSN determines which other users are proximately located to the users and in block 213 presents information to the users about the other proximately located users. In some embodiments, the information is presented without the use of a map or other mechanism that would provide exact location information. In other embodiments, the information may be presented on a map or similar instrument, either exactly or inexactly (e.g., randomly displaced by a certain distance so that some element of privacy can be maintained).

The PSN can then return to any of the prior blocks 201-213 to continue processing proximity information.

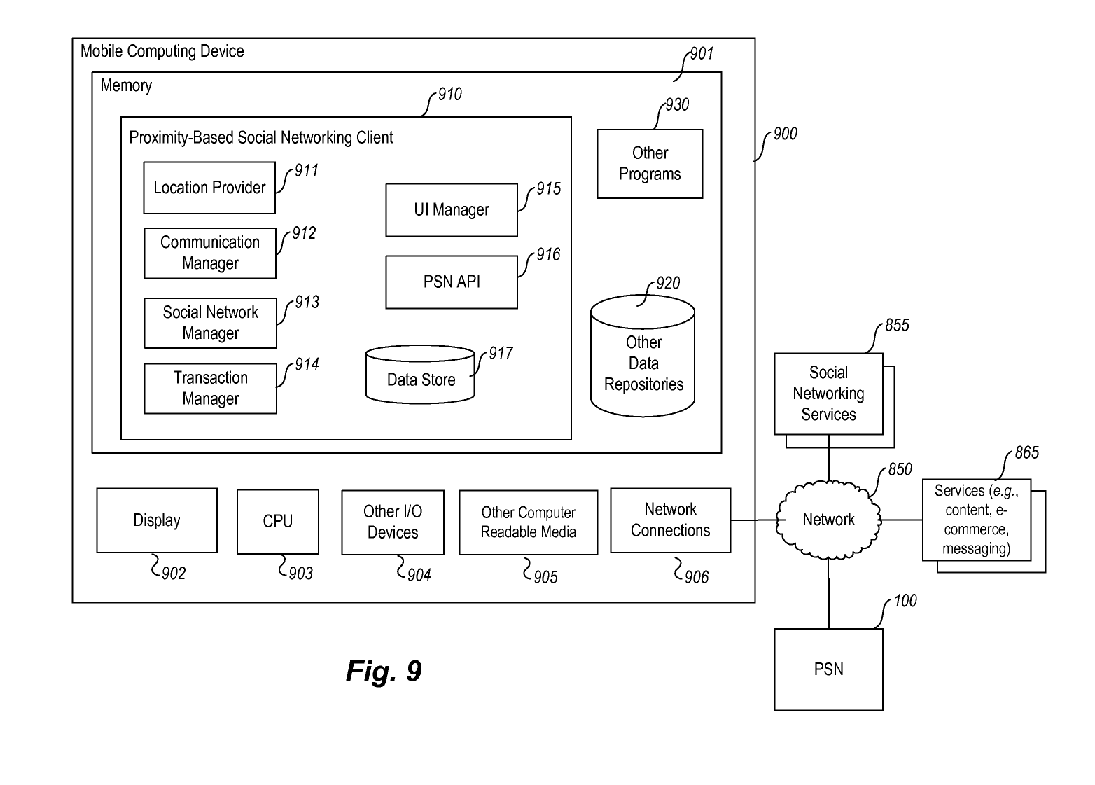

FIG. 2B is an example flow diagram of an example proximity-based social networking client process performed by an example embodiment. The illustrated process may be performed by, for example, logic in a client device operated by a user to interact with the PSN 100 as described, for example, with respect to FIG. 1. An example mobile computing device used as a client device is described with reference to FIG. 9, below.

The process starts at block 251, where it transmits location information. Transmitting location information may include transmitting location information to the PSN 100, or some intermediary system. Location information may include location coordinates, such as may be obtained from a GPS receiver that is part of the client device or some associated device (e.g., a car-based GPS receiver).

At block 252, the process transmits an indication that a user wishes to share information about himself with other users. The indication is typically transmitted to the PSN 100, and may include an indication of a visibility setting (e.g., all friends of friends) and/or a profile, such as a social, work, or interest-based profile that the user wishes to have applied in determining proximately located user.

At block 253, the process receives an indication of one or more users who are proximately located to the user. The indication is typically received from the PSN 100, and includes one or more indications (e.g., user names) of uses who are nearby and/or who otherwise match any proximity-determining criteria specified by the user.

At block 254, the process presents information about the one or more users. Presenting information about the users may include displaying, on a display of the client device, a list of the proximately located users. It may also or instead include other or auxiliary information gleaned from the social network(s) to which the users are affiliated, including status updates, feed information items, photos, contact information, or the like.

The client process can then return to any of the prior blocks 251-254 to continue processing location information.

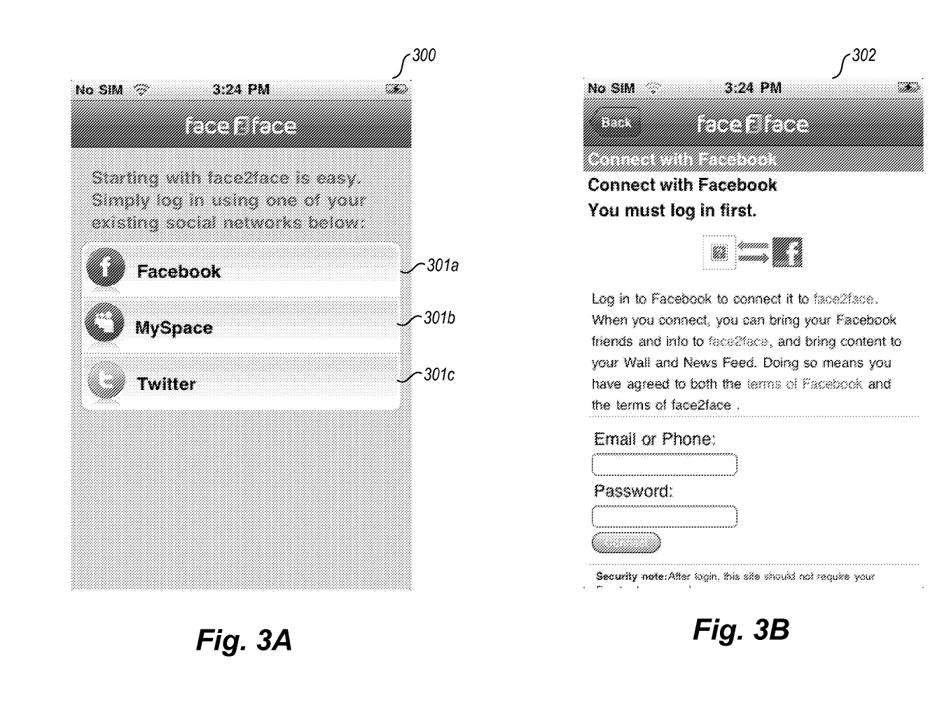

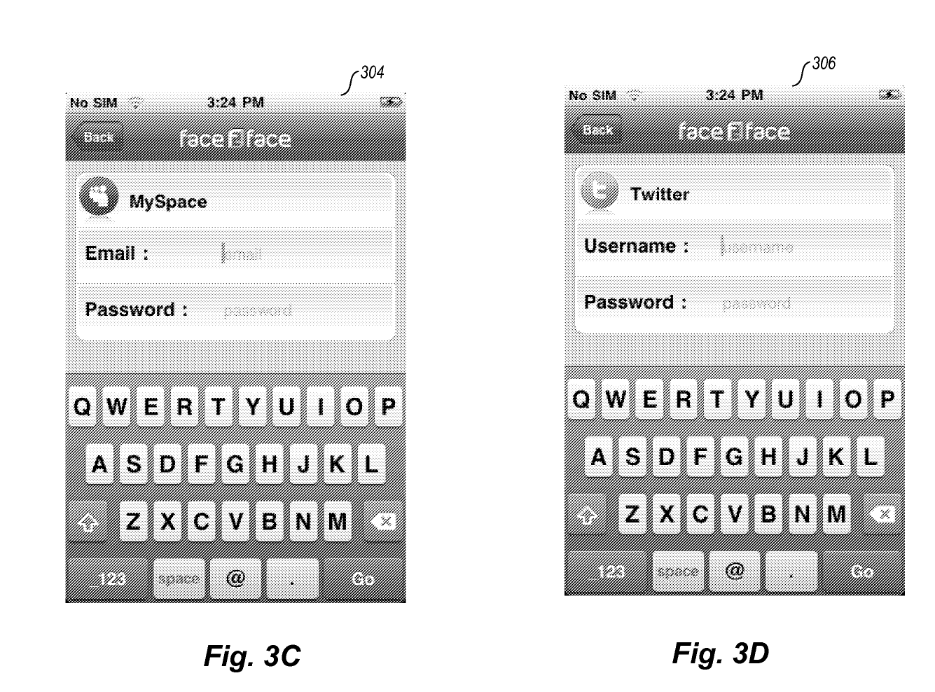

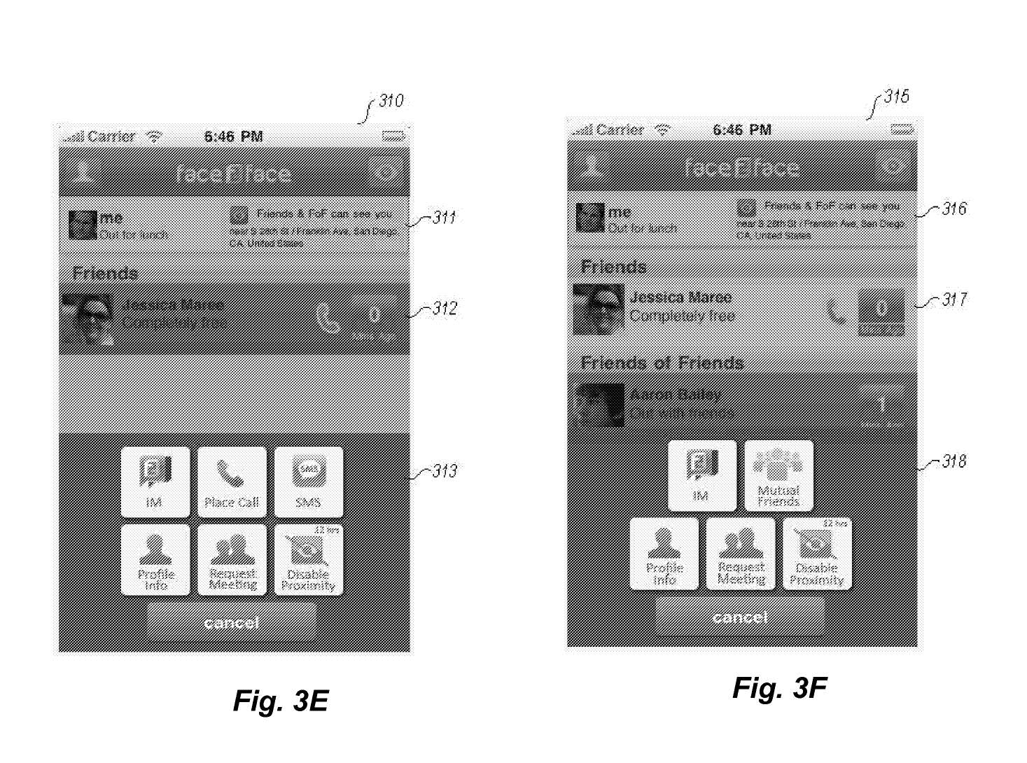

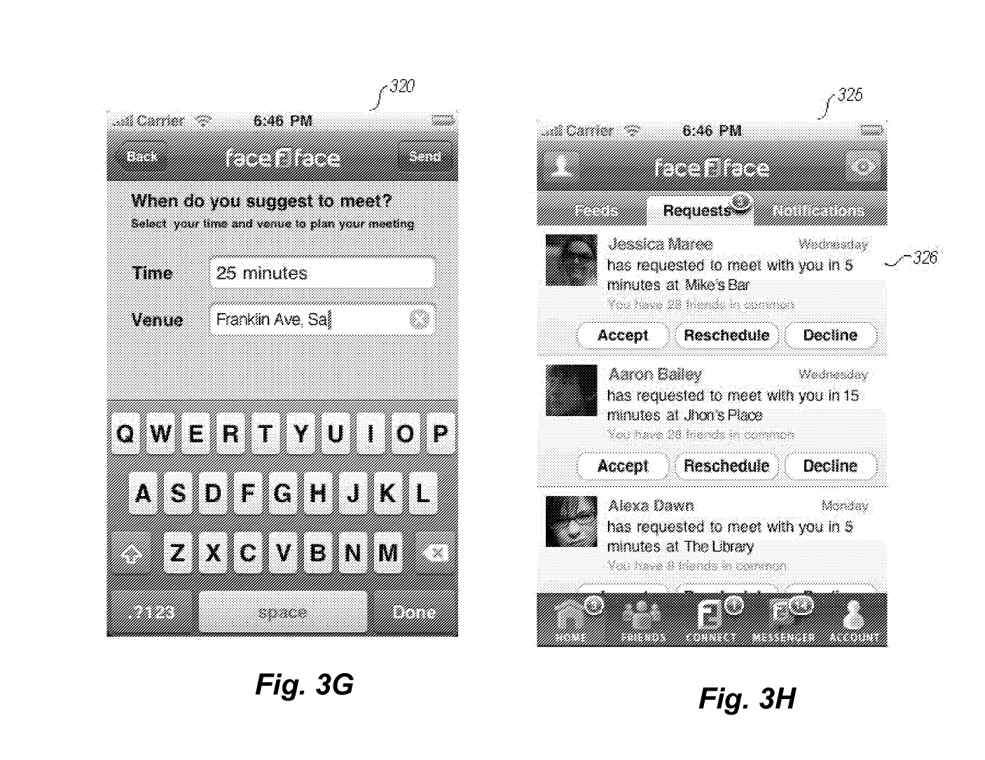

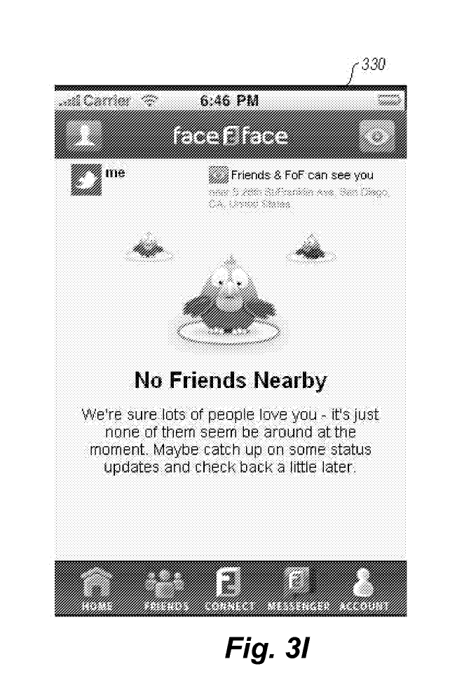

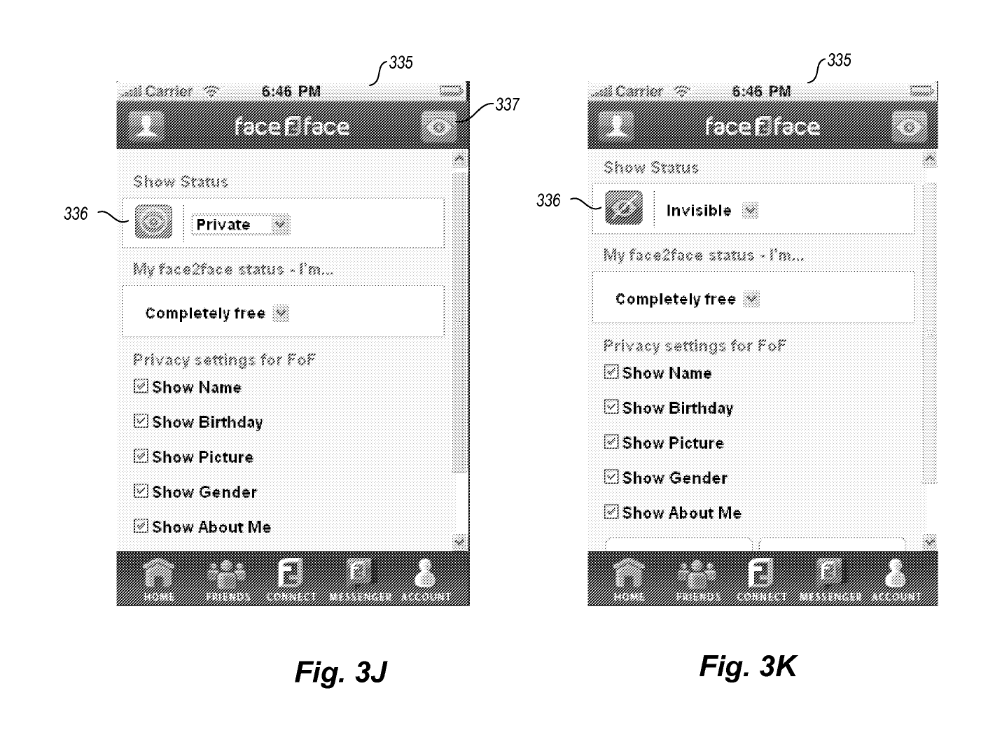

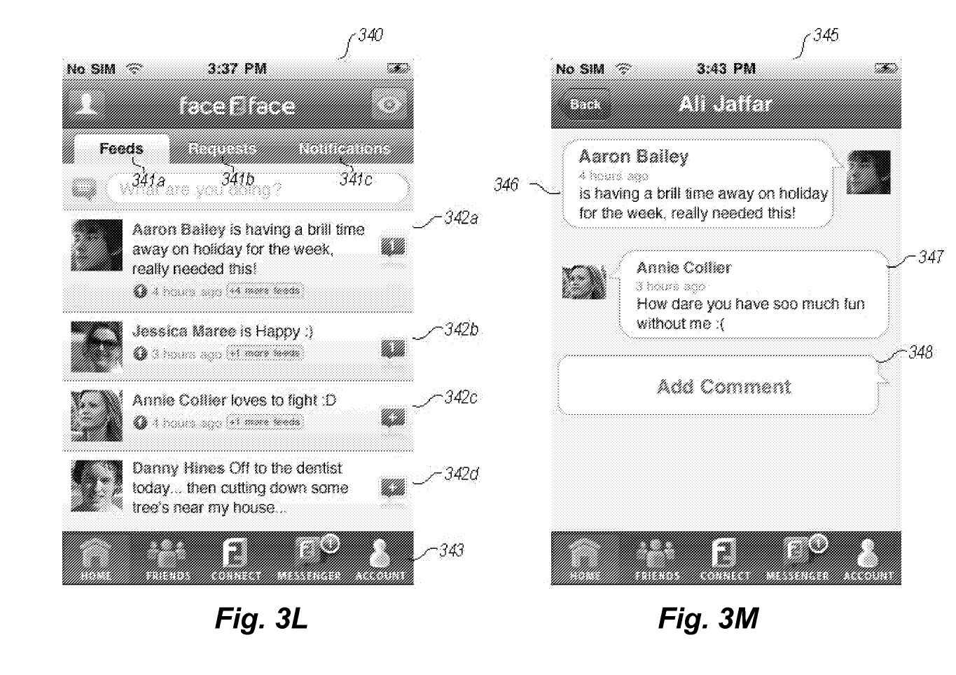

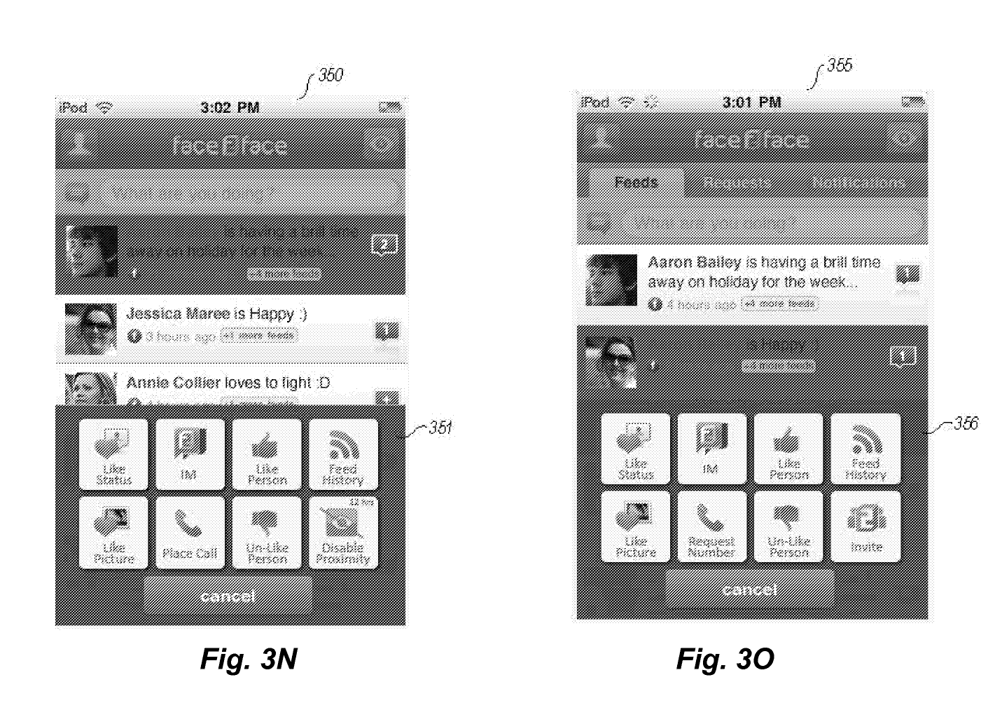

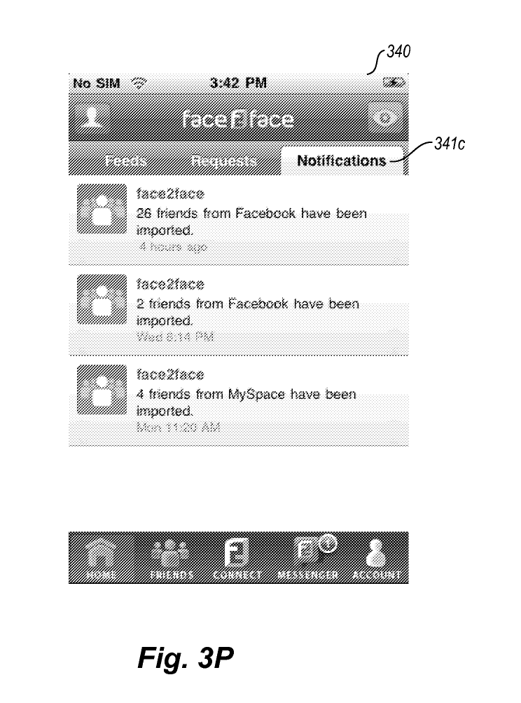

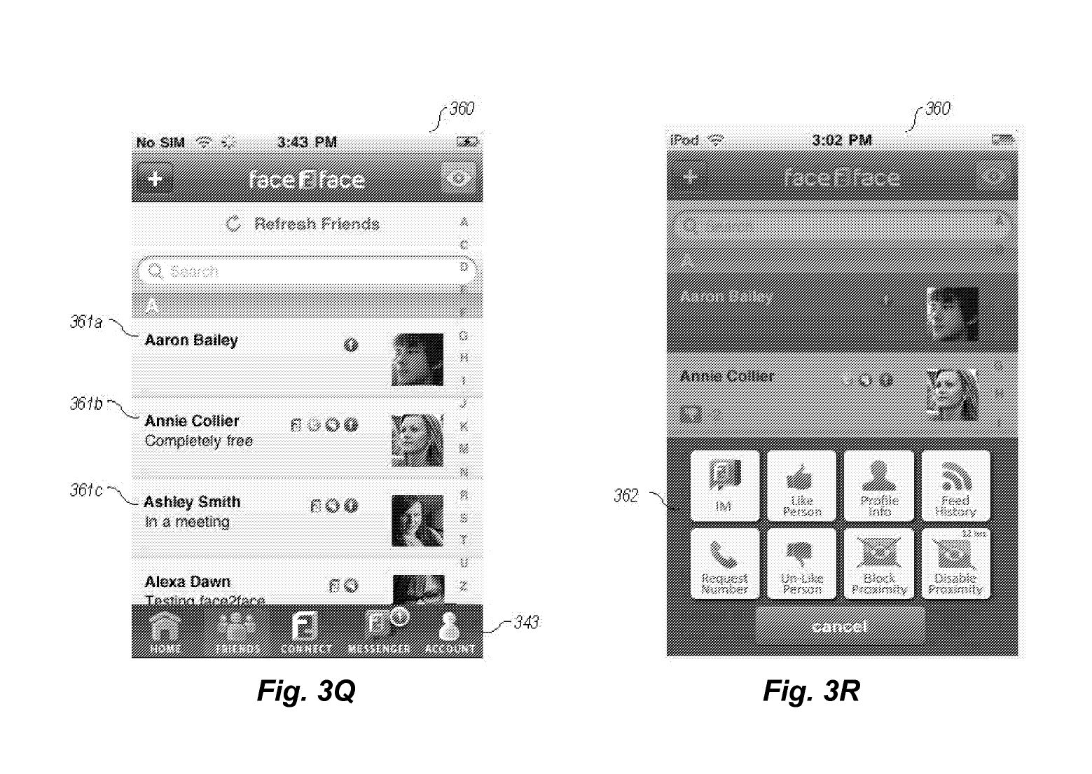

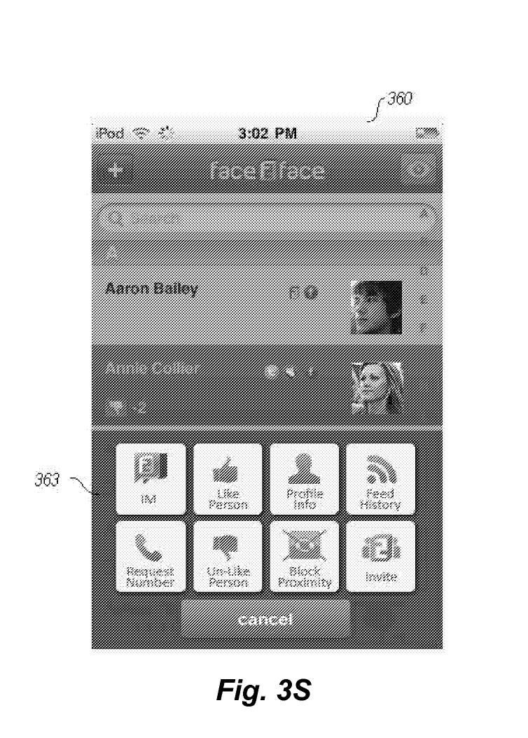

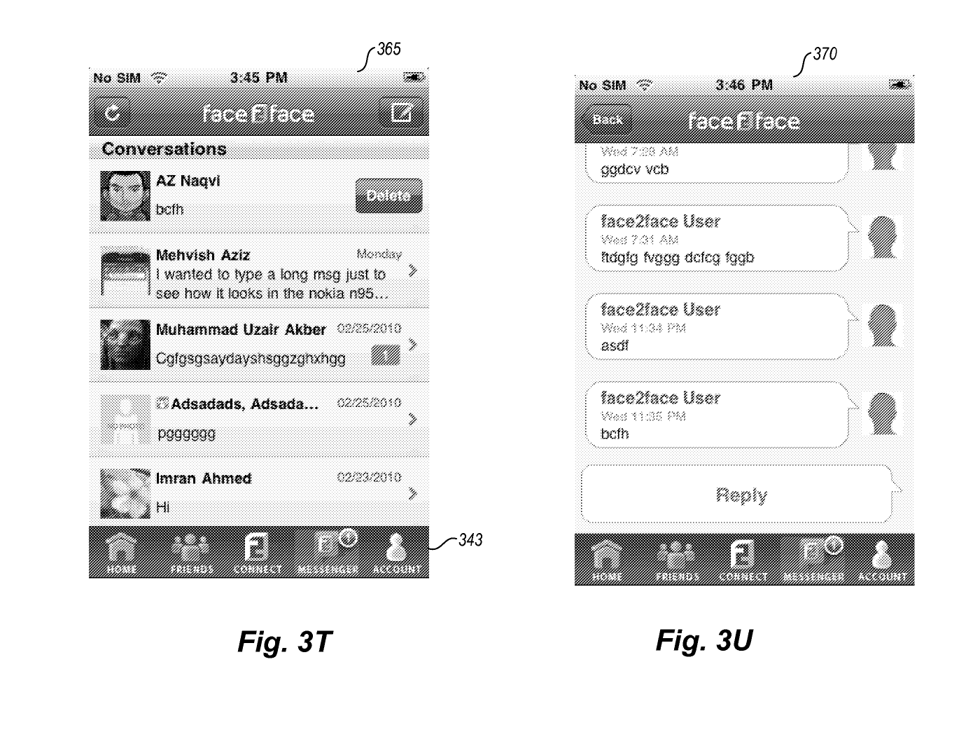

In other embodiments, the process described in FIG. 2B may perform other or additional operations. For example, the process may perform various of the feed and status update aggregation and/or display techniques described below. Furthermore, the process may provide or initiate various communication services to or for the user, including messaging services, voice services, and the like. In addition, the process may govern the display of various user interface functions and/or aspects, such as those described with reference to FIGS. 3A-3U, below.

Although the techniques described herein are generally discussed with respect to social networking services, they are applicable in other environments, including media sharing environments (e.g., photo sharing, video sharing), location-based services, contact management environments (e.g., corporate directory services), and the like. Other embodiments of the described techniques may be used for other purposes, including for proximity-based travel guides, transaction facilitators, and the like. In addition, although the PSN is described herein primarily as not using a map or similar instrument to provide information about other users, many of the described techniques are applicable to map-based social networking systems or environments. For example, many of the aggregation (e.g., feed and status aggregation) and/or proximity (e.g., probable proximity, predictive proximity) techniques may be deployed or implemented within the context of a map-based social networking system or other location-based service.

Also, although certain terms are used primarily herein, other terms could be used interchangeably to yield equivalent embodiments and examples. For example, it is well-known that equivalent terms in the social networking, mobile device fields and in other similar fields could be substituted for such terms as “friend,” “mobile device,” etc. Specifically, the term “mobile device” can be used interchangeably with “portable device,” “mobile client,” “portable client,” etc. Likewise, the term “friend” can be used interchangeably with the terms “relation”, “connection,” “link,” etc. In addition, terms may have alternate spellings which may or may not be explicitly mentioned, and all such variations of terms are intended to be included.

Example embodiments described herein provide applications, tools, data structures and other support to implement the described techniques to be used for proximity-based social networking. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the described techniques are not limited by the particular order, selection, or decomposition of steps or modules described with reference to any particular routine or system diagram.

### 2. User Interface Aspects

FIGS. 3A-3U illustrate example client device screen displays provided by an example embodiment of a proximity-based social networking facilitator system. In particular, the illustrated screen displays are presented on a client device and utilized by a device user to interact with the functions of the PSN. Various types of client devices are contemplated, including smart phones, personal computers (e.g., desktop, laptop systems), tablet computers, personal digital assistants, and the like.

FIGS. 3A-3D show example log in screens. Note that the illustrated embodiment of the PSN does not require the user to create a distinct user account to access its services. Instead, the PSN leverages a user's existing account(s), such that relevant information (e.g., contacts, feeds, updates, etc.) associated with those accounts is surfaced in the environment provided by the PSN, without asking the user to generate and remember yet another username and/or password or to manually migrate personal information from one platform to another.

More particularly, FIG. 3A shows a main login screen 300 that provides controls 301a-301c for logging using credentials associated with three distinct social networking services, in this case, Facebook, MySpace, and Twitter, respectively. Upon user selection of one of the controls 301a-301c, a respective one of screens 302 of FIG. 3B, 304 of FIG. 3C, or 306 of FIG. 3D is displayed. Screens 302, 304, and 306 respectively are Facebook, MySpace, and Twitter login screens. Each screen 302, 304, and 306 includes user interface controls configured to receive login credentials (e.g., user name, email address, password) and provide the received credentials to the corresponding social networking service. Upon authentication by the corresponding social networking service, the user can access functions of the PSN, as described herein.

FIGS. 3E-3I illustrate proximity-based social networking to facilitate in-person meetings. As discussed above, when users are in proximity with one another, the PSN will inform the users of that fact, without disclosing the exact locations of any of the users. The PSN then facilitates an in-person (e.g., face to face) encounter between proximately located users by providing functions and/or services that allow users to arrange meetings with other users.

More particularly, FIG. 3E depicts a notification screen 310 used to notify a device user that one or more other users are proximately located to the device user. Screen 310 includes a status control 311, a nearby friends control 312, and a menu 313. The status control 311 provides information about the device user's current state, including name, status (e.g., “Out for lunch”), and visibility setting (e.g., “Friends and Friends of Friends can see you). The nearby friends control 312 provides information about nearby users who are friends of the device user. In the illustrated example, the nearby friends control 312 provides information about one user (“Jessica Maree”). When the device user selects the displayed friend, the menu 313 is made active by the client device.

The menu 313 provides controls that can be utilized by the device user to interact with a selected one of the nearby friends in various ways. In particular, the menu 313 includes buttons to initiate communication (e.g., “IM,” “Place Call,” and “SMS”), to access profile information for the friend (e.g., “Profile Info”), and to temporarily disable proximity (e.g., “Disable Proximity—12 hours”). The PSN supports various communication mechanisms, including instant messenger, voice communications (e.g., via a cellular telephone network, voice over IP network, etc.), short message service (“SMS”), and the like. In some embodiments, the PSN is configured to provide cross-network communication, such as by operating as a proxy between multiple instant messenger services, such that a user can transparently communicate with another user without specific knowledge about which instant messenger service the other user is currently using. Messaging services provided by the PSN are described further with respect to FIGS. 3T and 3U, below.

The PSN also facilitates fine-grained proximity control. As shown here, by selecting the “Disable Proximity” control of the menu 313, the device user can temporarily block the sharing of proximity information with respect to the displayed person. After a predetermined period of time (e.g., 12 hours), proximity information will again be shared with respect to the displayed person. In this manner, the device user can conveniently and efficiently become invisible with respect to a particular person for a temporary period. In other embodiments, the device user can select the time period. In further embodiments, other types of visibility control are provided. For example, a user may create one or more profiles (e.g., work, social, sports, dating, politics) that include indications of users, so that only users in a particular selected profile are provided with proximity-based information about the user.

The PSN also facilitates the arrangement of in-person meetings between two or more users. In this example, if the device user selects the “Request Meeting” button of the menu 313, the client device will present a meeting request screen, as described below with reference to FIG. 3G.

FIG. 3F depicts another example notification screen 315 used to notify a user that one or more other users are proximately located. The notification screen 315 is similar to the notification screen 310 (FIG. 3E), except that the screen 315 includes a nearby friends control 316 as well as a nearby friends of friends control 317. In this example, the device user has selected the friend of friend (“Aaron Bailey”) indicated by the control 317, and in response, the client device has made menu 318 active.

Menu 318 is similar to menu 313 (FIG. 3E), except that menu 318 includes a mutual friends control and does not include controls to initiate a telephone call or SMS (because the friend of friend user's telephone number is not currently known to the client device). The mutual friends control can be selected by the device user to display those friends that are in common between the device user and the selected friend of friend. In this manner, the device user can obtain information about the connections between himself and some other user that is separated by more than a single degree of separation. Again, the device user can select the “Request Meeting” button of the menu 318 to access a meeting request screen, described next.

FIG. 3G illustrates a meeting request initiation screen 320. When the device user selects a user displayed as in FIGS. 3E and 3F, above, the screen 320 is presented. The meeting request initiation screen 320 includes user interface controls that can be utilized by the device user to initiate transmission of a meeting request to some other user. In the illustrated example, the device user suggests a meeting time and venue, and then the client device transmits a meeting request to the client device operated by the other user.

FIG. 3H shows a meeting requests screen. In particular, FIG. 3H illustrates a meeting requests screen 325 that can be used for viewing and possibly accepting in-person meeting requests received from other users. Here, the screen 325 is presented to, and used by, a user who has received one or more meeting requests such as the one transmitted as described above with reference to FIG. 3G. The screen 325 includes a request response control 326 that provides information about the user that made the request, information about the user, and that can be operated by the device user to accept, reschedule, or decline a received request.

The illustrated request mechanism of FIGS. 3E-3H is one way in which the PSN facilitates the arrangement of in-person meetings between users. As noted, the PSN does not disclose exact location information for any users. Rather, once a first user is notified that a second user (e.g., a friend, a friend of a friend) is nearby, the first user can send the second user a meeting request, suggesting some nearby location where the two users can meet in person. In this way, the PSN facilitates mutual, voluntary, and possibly serendipitous face to face interactions between people. Other mechanisms for arranging meeting requests are contemplated, including the initiation of a telephone call, the transmission of a text message, email, chat, or the like.

FIG. 3I shows a notification screen 330 that is used to notify the device user that there are no friends or friends of friends nearby. In some embodiments, a user may be able to specify or scale the proximity determination, such that the user can obtain information about users who are, for example, in the same city but who are not necessarily “nearby” (e.g., within 500 meters). In such cases, an option to increase the scope of the proximity determination may be provided on a screen such as notification screen 330, in response to a determination that no nearby users have been located.

FIGS. 3J and 3K show visibility controls. In particular, FIG. 3J shows a settings screen 335 that includes a visibility control 336. The visibility control 336 can be set to one of three settings: available, private, and invisible. Available mode is indicated by the icon 337. In available mode, the PSN provides proximity-based information about (and to) friends as well as friends of friends. In the example of FIG. 3J, the user is using control 336 to change his current visibility mode to private. In private mode, the PSN only provides proximity-based information about (and to) friends, and not about or to friends of friends. In the example of FIG. 3K, the user is using control 336 to change his current visibility mode to invisible. In invisible mode, the PSN does not provide any proximity-based information about (or to) anyone. The screen 335 also includes controls to specify what types of personal information are to be share with other users, including name, birthday, gender, and the like.

FIGS. 3L-3P show various home screen tabs. As shown in FIG. 3L, after logging in, as described above, the device user is presented with a home screen 340 that includes a feeds tab 341a, a requests tab 341b, and a notifications tab 341c. The feeds tab 341a is described immediately below, the requests tab 341b was described above with reference to FIG. 3H, and the notifications tab 341c is described with reference to FIG. 3P, below. At the bottom of the home screen 340, there is a function bar 343 that can be utilized by the device user to access various other functions of the PSN. In particular, the function bar 343 includes a home button which provides access to home tabs as described with reference to FIGS. 3L-3P; a friends button which provides access to social network information and management functions as described with reference to FIGS. 3Q-3S, below; a connect button which provides access to proximity-based user information functions as described with reference to FIGS. 3E-3I, above; a messenger button which provides access to communications functions as described with reference to FIGS. 3T and 3U, below; and an account button which provides access to visibility settings and other functions as described with reference to FIGS. 3J-3K, above.

In FIG. 3L, the feeds tab 341a includes feed information (e.g., status updates) organized by user. In particular, the feeds tab 341a includes feeds 342a-342d that each provide include summary information about feed items provided by a corresponding user, including the name of the user providing the feed, a snippet of some of the feed information (e.g., some text or an image), timing information (e.g., how long ago the feed was updated), and the like.

The feeds shown in the feeds tab 341a have been aggregated by the PSN based on factors including user proximity and user affinity. For example, the PSN may filter the feed items shown such that only feed items from proximately located users are displayed. As another example, the PSN may order the feed items based on some measure of affinity between the device user and the users providing the feed items, such as how frequently two users interact with one another, specific negative/positive feedback provided by one user about another, or the like.

FIG. 3M shows a feed detail screen. Upon selecting one of the displayed feeds, such as feed 342a, a feed detail screen 345 is presented. The feed detail screen 345 includes multiple user interface controls configured to display the feed information 346 and comments 347 left by other users. The feed detail screen 345 also includes a message box 348 that can be used by the device user to add a comment to the currently displayed feed item.

FIGS. 3N and 3O show user menus. In particular, FIG. 3N shows a screen 350 that includes a user menu 351 for a person who is also a user of the PSN. FIG. 3O shows a screen 355 that includes a user menu 356 for a person that is not a user of the PSN. The menus 351 and 356 can be accessed in various ways, such as from any portion of the device user interface that displays or otherwise presents information about other users (e.g., a feed tab, a messaging interface, a requests tab, an address book, and the like).

In FIG. 3N, the menu 351 is presented when the device user selects or otherwise indicates a person who is also a user of the PSN. The menu 351 includes controls (e.g., buttons) to initiate communication (e.g., “IM,” and “Place Call”), to indicate (dis)like for the person (e.g., “Like Person,” “Un-like Person”) or associated information (e.g., “Like Status,” “Like Picture”), to access feed information provided by the person (e.g., “Feed History”), and to temporarily disable proximity (e.g., “Disable Proximity—12 hours”).

A user of the PSN can express affinity for a person or associated data in various ways. By selecting the appropriate controls of the menu 351, the user can indicate that he likes or dislikes the displayed person, their current status, or their displayed picture. The PSN may utilizes this information when determining how to aggregate feeds received from multiple persons, such that feeds from the more socially proximate persons are displayed prior to those more distant persons.

In FIG. 3O, the menu 356 is presented when the device user selects or otherwise indicates a person who is not a user of the PSN. The menu 356 is similar to menu 351, except that the menu 356 does not include a control for temporarily disabling proximity, because the person who is not a user of the PSN can never receive any proximity-based information about the device user. Instead, the menu 351 includes a control for initiating transmission of an invitation to join the PSN.

FIG. 3P shows a notification tab. In particular, FIG. 3P shows the home screen 340 with the notification tab 341c displayed. The notification tab provides information about recent events in the PSN, such as recent automatic imports of information from other social networking services.

FIGS. 3Q-3S show social network information and management screens. In particular, FIG. 3Q shows a friends information screen 360. The friends information screen 360 provides indications 361a-361c of multiple friends of the device user. Note that the PSN aggregates (collapses) information from multiple social networks. Aggregation includes displaying information about friends known via different social networking services in a single directory or list. Here, each friend indication 361a-361c is annotated with an indication of the social networking services of which the corresponding friend is a member. Thus, indication 361a shows that the corresponding friend is a member only of a first social networking service (Facebook), whereas indication 361b shows that the corresponding friend is a member of three social networking services (Facebook, Twitter, and MySpace) as well as being a user of the PSN itself. Accordingly, even though the displayed friends may be members of different, possibly non-overlapping social networking services, the PSN can still aggregate information about the displayed friends, such that all friends appear in a single directory.

FIG. 3R shows a menu for friends who are users of the PSN. In particular, FIG. 3R illustrates a menu 362 presented on screen 360 in response to selection of one of the friends indicated by screen 360, where the selected friend is a user of the PSN. The menu 362 includes controls (e.g., buttons) to initiate communication (e.g., “IM,” and “Request Number”), to indicate (dis)like for the person (e.g., “Like Person,” “Un-like Person”), to access information about or provided by the person (e.g., “Profile Info,” “Feed History”), to control proximity (e.g., “Block Proximity,” “Disable Proximity—12 hours”). Many of these functions are similar to those discussed elsewhere above. In addition, the device user here can permanently (or at least until the setting is reversed) disable proximity with respect to the selected user, by selecting the “Block Proximity” button.

FIG. 3S shows a menu for friends who are not users of the PSN. In particular, FIG. 3S illustrates a menu 363 presented on screen 360 in response to selection of one of the friends indicated by screen 360, where the selected friend is not a user of the PSN. The menu 363 is similar to menu 362 except that it does not include a “Disable Proximity” control, and instead includes a control that can be used to transmit an invitation to join the PSN to the selected user (“Invite”).

FIGS. 3T and 3U show messenger screens. FIG. 3T shows a conversations screen 365 presented in response to user selection of the “Messenger” button on the function bar 343. The conversations screen 365 includes multiple message threads that the device user is engaging in with different users. FIG. 3U shows a single message thread screen 370 presented in response to selection of one of the message threads displayed in screen 365. The screen 370 includes a sequence of multiple messages exchanged between the device user and another user, as well as a reply control that can be used by the device user to compose and transmit another message.

### 3. Proximity-Based Operations

As noted above, the PSN supports a concept of proximity that is broader than mere location, and provides an array of functions based on proximity. Various proximity-related concepts and functions will be discussed in more detail below.

Location Tracking

The PSN tracks user locations by communicating with user client devices. In one embodiment, each client device provides (e.g., transmits) a “heartbeat” of its current location as determined via a global positioning system (“GPS”) receiver or other location information provider component (e.g., radio frequency identifier transceiver) of the client device. Different protocols for transmission of client device heartbeats are contemplated. In one embodiment, each client device transmits its location at regular intervals (e.g., every minute, every five minutes). In another embodiment, each client device transmits its location at regular intervals or whenever the client device has moved more than a specified distance. In such an approach, the PSN will receive more frequent updates when a user is on the move, so that the user's position can be tracked in a more finely grained manner. Also, different push/pull protocols may be used. For example, in some cases the PSN may request a client device to provide a location update (e.g., a pull), such as when the client device has not been heard from for some time.

In tracking user location, the PSN may over time develop a location history for each user. The PSN may also provide functions for presenting, filtering, or manipulating location histories based on various factors, including who, what, where, and when. Such functions may be exploited internally by the PSN, or provided, in possibly anonymized form via an API or other mechanism to third parties, including online services (e.g., e-commerce systems), application developers, policy makers, or the like. Further example uses of location history are discussed below.

Different techniques for determining the location of a client device are contemplated. For example, in some embodiments, the client device includes no special hardware or component for determining location (e.g., a GPS receiver). Instead, client device location can be determined by, for example, a network or service provider, such as by triangulating one or more signals received from the client device. In other embodiments, a network of sensors (e.g., RFID interrogators) may be used to instrument certain locations (e.g., shopping malls, hotels, city cores) and provide location information to the PSN.

Probable Proximity

In some embodiments, the PSN expresses and determines proximity in a probabilistic manner. Determining a probable proximity includes persisting (e.g., maintaining) a last known location of a user in the presence of a lack of location information from the user's client device. A client device may not be able to transmit its location for various reasons, including an inability to obtain location information (e.g., because it is in a shielded location), an inability to run or otherwise execute the relevant software/hardware (e.g., due to a system fault, inability to run background tasks, etc.), transmission outage, battery depletion, and the like. In such cases, the PSN may elect to persist the user's last known location for a period of time (e.g., a half hour) or until it receives another location information transmission from the client device. In other cases, the PSN may associate a likelihood with the user's last known location, wherein the likelihood decreases as the time since the last received heartbeat increases.

Probable proximity can be controlled or modified in various ways. In some cases, a user may specify a time period during which their location information should be persisted. For example, when a user is at work, he may specify that his location will remain the same until lunchtime. In other cases, the PSN learns, based on a location history, travel patterns of the user (e.g., that the user is typically at a work location during weekday business hours), and can configure the client device to decrease the heartbeat frequency. Probable proximity can thus reduce the impact on the battery life of the client device, as well as facilitate a continued ability to provide proximity-based services even though the client device is temporarily incapable of providing location information.

In addition, the PSN may automatically override a determination of probable proximity, such as when it receives information that it believes to be more accurate and/or recent. For example, if a user indicates that he will be at a location for four hours, the PSN will persist that user's location for four hours, unless it receives location information from the user's device reflecting a new location, and thus indicating that the user has departed the original location.

In some embodiments, the user may be able to completely override any proximity-based determinations made by the PSN, including but not limited to actual, probable, predicted proximity. In this way, the user is given the final decision as to whether the PSN obtains and/or utilizes information about the user, such as location information, social networking information, usage information, and the like.

Predictive Proximity

In other embodiments, the PSN includes functions for predictive proximity. Predictive proximity includes predicting the location of a user based on various factors, such as a user's location history and/or other user behaviors. By generating a history of locations visited by a user, the PSN can predict one or more locations at which the user is or will be at some future time.

Predictive proximity facilitates suggestive capabilities in the PSN. In particular, the PSN may suggest (e.g., recommend) destinations or activities for users, based on the past and predicted behaviors of the users. For example, based on a prediction that a user will visit a particular part of town on a Friday night (based on the fact that the user frequents that or a similar part of town on weekends), the PSN may suggest one or more restaurants, clubs, or other activities that are located in that part of town. As another example, the PSN may suggest that a user visit a particular destination (e.g., club, restaurant, park, neighborhood), based upon a prediction that multiple of the user's friends will also be at or near that destination.

Proximity-Based Transit Support

In some embodiments, the PSN supports various public or private transit-oriented behaviors based on proximity. For example, the PSN may utilize one or more users' travel history to determine appropriate partners for rideshares or carpools. For example, if the PSN determines that two users have similar travel patterns (e.g., traveling from about the same origin location to about the same destination location at about the same times) the PSN can notify the two users of the potential for a suitable carpool arrangement. Of course, the PSN may take other factors into account, such as the social proximity of the users, such as in preferring to suggest carpool arrangements to users who are friends or friends of friends.

Note that such determinations can be made dynamically, in response to changed circumstances. For example, if a user needs to stay late at work and thus miss his customary carpool or other transport (e.g., bus), the PSN can suggest other proximately located users that may be able to provide transport at a later time.

Proximity-Based Vacation/Travel Information

Some embodiments of the PSN include a vacation/travel mode. In this mode, a user indicates to the PSN that he is traveling or vacationing. Then, when the user visits a city (or other defined region/place), the PSN exchanges information between the user and his friends or other contacts that are also in the city. Exchanging information between the user and his friends includes notifying the user that his friends are in the current city, and vice versa. In this way, the user can conveniently contact locally situated friends and arrange for a meeting. Vacation mode effectively expands the scope of the proximity determination made by the PSN, so as to identify proximately located users over a larger scale.

Exogenous Data

The PSN can import and otherwise make use of exogenous data in various ways. As noted above, the PSN readily accesses (e.g., consumes information from, initiates functions of) external social networking services, messaging services, media sites, and the like.

In addition, the PSN can generate (populate) a location history for a user even before the user has spent any appreciable amount of time using the PSN. For example, when a user registers with the PSN, the PSN can search through an external archive (e.g., a photo sharing site such as Picasa or Flickr) of geo-tagged photographs to generate an initial location history for the user. The PSN may identify the user in one or more photographs by using face recognition techniques and/or based on user-supplied tags, and then associate the user with the location and time at which the photo was taken.

As another example, the PSN can consume location information provided by other location-based services. For example, by using credentials supplied by a user, the PSN may access that user's location history, preferences, or other information from a location-based travel guide service.

Proximity-Based SOS and User Assistance

In some embodiments, the PSN provides SOS or user assistance services that are proximity-based. In particular, when a user indicates that they need help, the PSN may alert or otherwise notify other users based in a proximity-based manner. For example, the PSN first notifies nearby users who are also friends of the in-need user. Failing to obtain any response from the first set of notified users, the PSN then elects to notify nearby users who are friends of friends of the in-need user. The PSN may continue to expand the set of notified users by geographic and/or social proximity until the in-need user has received a response and/or assistance. The PSN may of course take other factors into account, including the type and/or behaviors of the notified user(s). For example, if a user requests assistance from a nightclub, the PSN may prefer to notify social friends of the user rather than work colleagues.

Space-Based Proximity

Embodiments of the PSN go beyond straight-line distance to represent geographic proximity, such as by representing geographic proximity by using a hierarchically composed structure of spaces. Each space represents a region in two or three dimensional space, such as may be bounded by a polygon, circle, sphere, cube, or other geographic construct. Each space has a space coefficient or other measure of a cost, impediment, or time to travel through or in the space. The space coefficient can be based on various factors, including geographic, topographical (e.g., taking into account hills, rivers, and other impediments to travel), topological (e.g., with reference to the connectedness of the roads/streets of the space), density (e.g., population density) demographic (e.g., with reference to the social class of the residents of the space), sociological (e.g., with reference to crime statistics associated with the space), and the like. Each space may also include a connection (e.g., link, arc) to one or more other spaces, to represent a connection or containment between spaces. Space coefficients may instead or in addition be associated with the connections between spaces. In addition, for each user, the PSN may determine an affinity coefficient for all or some of the spaces. The affinity coefficient can be based on various factors, including past behaviors (e.g., how often the user has traveled to the space), social proximity (e.g., how many friends live or work in the space), personal interests (e.g., whether the space has or includes destinations that serve the user's interests), and the like.

Proximity-Based Information Sharing

In some embodiments, the PSN facilitates proximity-based information sharing. Proximity-based information sharing includes allowing users to “drop” or “place” information items or objects (e.g., notes, files, photos, videos, audio, and/or collections thereof) at (or associated with) particular locations, and making those information items available to one or more other users, based on the proximity of the other users. For example, a user may take and drop a photo at a certain location, such as a baseball stadium during a baseball game. This action will cause the PSN to associate the photo with a representation of the location of the baseball stadium (e.g., the latitude and longitude of the baseball stadium). The user may indicate that the photo is to be made available to specified users, such as friends, friends of friends, specific users, and/or custom groups of users (e.g., work friends). Later, when some of the specified users visit the baseball stadium, the PSN will notify them that the user has shared a photo with them, and provide them the option to view the photo. The PSN can thus provide highly relevant information to a user by filtering such information on both a set of users (e.g., the user's friends) and a location associated with the user.

As another example, a user may drop a review of a restaurant at or about the location of the restaurant, such that when the user's friends and/or other users are in proximity to the restaurant, they will be notified of the review. As a further example, a user can create a “guided tour” by attaching comments or other editorial content (e.g., “be sure to check out the view from atop the Columbia Tower”) to one or more locations or establishments.

Object-Based Architecture for Facilitating Proximity-Based Interactions

Some embodiments provide an object-based architecture for implementing a “virtual” world that is populated with objects that can be dropped to or associated with a location. These object-based techniques can be used to implement proximity-based information sharing (above) and other techniques described herein. In one embodiment of the architecture, objects and locations (which may themselves be modeled as objects) are aware, intelligent, and/or interactive. Users (or representations thereof) navigate a model, landscape, or virtual world that includes objects and locations, while performing actions on these objects.

An object may include an object name, which is an identifier or name for the object. Because a name may not be unique to a specific object, objects may also or instead include a unique object identifier. Example object types include place, coupon, offer, advertisement, super coupon, resume, friend, picture, multimedia, trip, scavenger item, scavenger hunt, wedding registry, guide, attachment, task, micro-task, gifts, contact, picture album, marketplace item, classified advertisement, event, business card, or the like.

An object can be created by a user, the system, an event (e.g., Madonna's concert at Madison Square Garden), a geo-tagged social networking message (e.g., a tweet), another object, or the like. Each object is associated to one or more locations. A location can have multiple objects.

Various actions can be performed on an object, including create, update, view, pick (e.g., bookmark), share, buy, drop, trash, barter (e.g., change in ownership), rate, review, bet, combine (e.g., pictures become an album), replace, sell, attach to a specified location, introduce, partial pay (e.g., charity, gift, user buys someone a fractional gift), rent (e.g., rent a song), comment, report, or the like.

Permissions and access rights may also be defined for objects. In one embodiment, permissions and access to an object depends on a combination of: ACTION (e.g., view, comment, buy), USER/GROUP (e.g., friends, friends of friends, individual, group, public, system), and WHEN (e.g., date, date range, time triggers). For example, a user can set a Picture Object to be viewable by only his Friends for the next 24 hours.

Extended attributes for an object may include one or more of: owner; age; expiry time; number of instances; affinity, which may be inherited from the object creator, location, or other objects in proximity; movable (e.g., move the object with the user/entity that holds it); and price.

Objects may be merged or transmuted in various ways. In one embodiment, objects may be copied and replaced. For example, given two similar objects, information about the objects is divided between the two objects and/or information is copied to one object and the other object is deleted. In another embodiment, objects may supersede one another. For example, a superseded object may be linked to an active object, which can be utilized to keep an object history.

Objects may have defined lifetimes. During the life of an object, users and objects may perform actions on the object. All data related to interactions and/or actions performed on the object may be persisted. For example, objects such as places persist for eternity; other objects such as coupons may live for X days/months; objects that are not being accessed (e.g., no action performed) may expire (e.g., an item for sale); an object can be removed/killed by the system; an object may die because it lost to another object (e.g., survival of the fittest).

Objects may behave intelligently. For example, the system can spawn one or more intelligent objects (e.g., “bots”) in a virtual world. These objects may be, for example, responsible for finding the best location where they will survive. Objects that are not accessed are expired after a certain time, thereby creating a survival of the fittest environment. A process for intelligent object processing may include the following: (1) create an intelligent object and define satisfaction criteria (e.g., object should be viewed by a user at least 3 times a day); (2) find locations that have a high affinity with this object; (3) score the list of locations; (4) put intelligent object in top scoring location; (5) wait for X days; (6) if satisfaction criteria are not satisfied, then repeat step 2, (7) optionally, if satisfaction criteria are satisfied, then create another instance of this object and start step (2).

Intelligent objects can be used for alpha or beta testing, such as for identifying the right price for an object, the right location for an object, and the like. For example, consider the case where the criteria defined was to try prices between $3-$7 for an item for sale for 7 days. The intelligent object could try this experiment in different locations and provide an optimal price for a product at a location.

As another example, consider the case where an intelligent object was a “lyrics object” for a Madonna song. This object may find itself placed at concert venue on the day of the concert, as the affinity was high of for this object given that a Madonna concert was taking place on that day. In a couple of days, the lyrics object is probably not going to be viewed by anyone since Madonna is no longer in concert, and the object would look for another suitable location. Suppose then that the lyrics object found Central Park as a suitable location, and that people were viewing it on a daily basis at that location. Since the satisfaction criteria have been met, the lyrics object clones itself and sends the clone looking for another spot where it may live.

Locations may themselves be modeled as objects. In one embodiment, a location is an area or a specific geo-location that has human relevance. A location may be stored as a specific geolocation (e.g., latitude/longitude) or a geolocation with a range (e.g., lat/long+20 meters) to demark an area. A location may be created when a user interacts or passes through a location, an object interacts or passes through a location, or a manual process to create a location is initiated. A virtual world model may thus be located on an as-needed or “lazy” manner. At the time of creation and instantiation, a location is automatically assigned a default set of characteristics. These characteristics are derived from exogenous data sources such as geopolitical databases, yellow pages, topographical/geological databases, informational datasets; affinity analysis from neighboring locations and objects; attributes from the creator of this location; or the like. The characteristics may also include default language, tags and any affiliations to this location.

At location creation time, the location may also be given permissions or access rights, including Read-Only (e.g., everyone can see the location but cannot add any objects); Read-Write (e.g., everyone can see and can add any objects); Read-Write with conditions (e.g., Read/Write is restricted to a person or a group; or only certain types of objects can be written (added) to this location, such as pictures only); Hidden (e.g., hidden for all except the system); or the like.

At location creation time, a default number of objects that can be stored in the location may be defined. Limitations may be imposed based on a combination of object types and/or access rights (e.g., may limit only 10 Coupons, 20 pictures for public view in a given location).

Locations may have defined lifetimes. During the life of a location, users and objects may interact or pass through the location. Users and objects may perform certain actions with other objects at the location. The location persists normalized data related to all interaction, usage, and other significant events. Stale objects are regularly cleaned up.

Game theory and other techniques may be used to ensure a healthy “competitive” locality. For example, consider a location where the maximum number of objects (e.g., coupons) allowed is four. There are two users who both want to put out multiple coupons. Using game theory or a scoring method, the location may find a solution which may result in automatic acceptance or rejection of certain coupons from these users.

Personal views of a location may also be generated, based on a personal history of a user and/or social recommendations. One example process for generating a personal view for a location identifies all objects in the location; identifies objects known to be of interest to the user (e.g., based on past behavior); identifies objects dropped/recommended by friends, friends of friends, people liked by the user, or the like; weights objects in a list that includes the above objects; sorts the list from highest to lowest; and filters the sorted list and creates a view.

Users can interact with objects in various ways, including: users can interact with objects when they are at or near a location that includes the objects; users can perform actions on these objects depending on the object permissions; users can create and drop objects to a location for friends or the world to see/interact with; and the like.

Personal recommendations for a user in a location may also be generated. To complement the personal view of the virtual world, a user may be given recommendations of objects and locations based on objects in a location that have a high affinity to other objects (e.g., in other locations). An example process for generating object recommendations for a user a location identifies objects known to be of interest to the user (e.g., based on past behavior); finds similar objects (e.g., that have a high affinity to another object) and places them in a list; weights objects in the list of objects; sorts the list from highest to lowest; and filters the sorted list and creates a recommendation.

An example process for generating location recommendations for a user at a location identifies locations of interest to the user (e.g., based on past behavior); finds similar locations (e.g., that have a high affinity to the location) and places them in a list; 3) weight locations in the list; sorts the list from highest to lowest; and filters the sorted list and creates a recommendation.

Dynamic and/or Overlapping Proximity

In some embodiments, the PSN supports a concept of dynamic proximity. In dynamic proximity, a distance measure used to determine when users are within proximity of each other changes dynamically in response to various factors, such as population density, user inputs, user affinity, or the like. For example, in less densely populated areas (e.g., suburbs, rural areas), a larger radius (e.g., 2000 meters) may be used, whereas in more densely populated areas (e.g., urban cores, shopping malls), a smaller radius (e.g., 200 meters) may be used. As another example, a user may specify by user input that he wishes to use a larger or smaller distance measure, in order to filter out more or fewer other users.

In addition, the PSN may use multiple different distance measures at or about the same time. For example, the PSN may use a larger radius to locate friends and a smaller radius to locate friends of friends, based on the intuition that a user may be willing to travel further to meet a close friend. As another example, as a travel application, the PSN may provide information about friends who are in the same city at the same time as information about other users (e.g., friends of friends) who are within a 500 meter radius. Furthermore, profiles or other filtering mechanisms may be combined during proximity determination. For example, a user may elect to receive information about social contacts on a city-wide basis and information about business contacts on a local (e.g., 500 meter) basis.

### 4. Aggregation Techniques

As noted above, the PSN provides powerful information aggregation services, including aggregation of social network information, identity information, feed and status information, and the like, as discussed further below.

Social Network Aggregation

The PSN can aggregate information from primary, secondary, or temporary social networks or other collections of users. Aggregating information from various social networks or other collections may include generating a social map or other graph structure of the relationships between multiple users. Primary networks include graph-based structures that are managed by social networking services and that represent information about user identities and relationships (e.g., friendship, colleague) between them. Secondary networks include implicit or informal groups or collections of users, such as may be defined by email lists (e.g., a soccer team email list), newsgroups, online communities (e.g., an online home improvement forum), address books, email domains (e.g., all users of a company email domain), fan lists, and the like. Temporary networks include ad hoc, nonpermanent collections of users, such as may be formed by or around conferences, current events or political issues, or the like. In addition, some embodiments can aggregate or otherwise form networks based on affinity. For example, the PSN may form a network that includes users who have a particular interest, such as dating, a sport, a current event, a political affiliation, a film, a band, a song, or the like.

Note that some embodiments of the PSN can also aggregate information received from various different communication (e.g., non-Internet based) services. For example, the PSN can receive telephone numbers and contact information from address books, friends and family lists, and/or frequently called numbers maintained by telecom providers, and integrate and/or aggregate the received information into a contact list or other representation provided to a user.

By aggregating social networking information, the PSN can also provide various social analytics functions to help users better understand and maintain their social connections. For example, the PSN can provide a statistical overview and/or profile of a user's social network, including information such as the demographic breakdown (e.g., percent male/female), frequency of interaction, type or group (e.g., work related, sports related), and the like. The PSN may provide a ranked or ordered view of friendships or other relationships, based on one or more factors, such as frequency/type of interaction, likes/dislikes received by the system, and the like. In addition, the PSN may suggest or recommend that a user take particular actions to maintain and/or develop friendships or other types of relationships. For example, a user may indicate that he wishes to keep a particular person at a certain “level” of connectedness, and in response, the PSN may periodically (e.g., every two months) suggest that the user contact or otherwise communicate with that person. Other types of actions may include sending birthday, anniversary, or other types of greetings to persons that a user wishes to cultivate as friends. Such greetings (or other actions) may be sent or performed automatically by the PSN and/or based upon user specification and/or scheduling.

Identity Aggregation

The PSN can aggregate identity information about persons who are related to a user. Identity aggregation includes collapsing information about a single user, such that a user who has identities on multiple social networking services appears as a single friend in a directory or other representation of user information provided by the PSN. In some cases, the PSN determines to collapse multiple social network identities associated with a single user into a single directory item when the single user becomes a user of the PSN and provides their login credentials for each of the relevant social networking services. For example, suppose user A has identities 1 and 2 on social networking services X and Y, respectively. When user A provides the PSN with credentials for services X and Y, the PSN can determine that identity 1 and 2 actually belong to user A, and initiate corresponding operations to collapse these identities into a single item in one or more user directories that may be provided to other users, such as friends of user A.

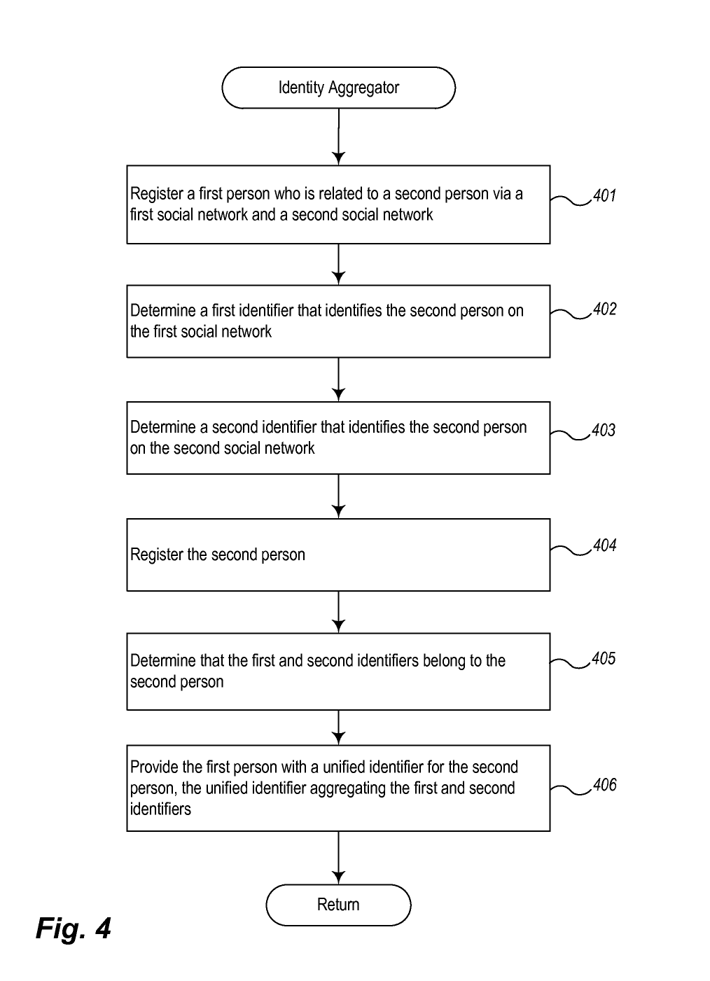

FIG. 4 is an example flow diagram of an identity aggregator process performed by an example embodiment of a proximity-based social networking facilitator system. The process may be performed by, for example, the user manager 113 described with reference to FIG. 1A. The process retrieves and aggregates user identity information from one or more social networks.

The process begins at block 401, where it registers a first person who is related to a second person via a first social network and a second social network. Typically, registering the first person includes receiving a request from the first person to join or otherwise become a user of the PSN. As discussed above, the person need not create a new user identifier for the PSN. Rather, the person simply provides credentials associated with one (or more) social networking services, which credentials then serve as his login credentials for the PSN.

At block 402, the process determines a first identifier that identifies the second person on the first social network. Using the first person's credentials for the first social network, the process obtains access to the first person's contacts, relations, friends, and other information represented, recorded, or otherwise managed by the first social network. In so doing, the process obtains a list of the first person's friends on the first social network which includes identifiers (e.g., usernames, email addresses, family names) for various persons. One of the received identifiers is the first identifier that identifies the second person on the first social network.

At block 403, the process determines a second identifier that identifies the second person on the second social network. At some point, the first person also provides the PSN with his credentials for the second social network. With these credentials, the process obtains a list of the first person's friends on the second social network, which again includes identifiers for various persons, one of which is the second identifier that identifies the second person. At this point, without more information, the process may not know that the first and second identifier identify the same person. For example, the identifiers may be different, such as “Bob” for the first network and “BobJ” for the second network, for a person named “Bob Jones.” In other cases, the identifiers may be the same, but actually identify different persons.

At block 404, the process registers the second person. Here, the second person provides credentials for the first and second social networks.

At block 405, the process determines that the first and second identifiers belong to the second person. Having received credentials for the second person on the first and second social networks in block 404, the process can now determine that the first and second person actually identify the same person. Continuing the above example, the process now understands that the person named “Bob Jones” uses login name “Bob” for the first network and “BobJ” for the second network.

At block 406, the process provides the first person with a unified identifier for the second person, the unified identifier aggregating the first and second identifiers. Having determined that the first and second identifiers refer to the second person, the process can now collapse those identifiers in any representations (e.g., directories, contact lists) provided to other users. In particular, this may include providing the first person with a contact list that includes a single entry for the second person, the entry listed or accessed under a unified identifier. The unified identifier can be the second person's given and/or family name, a frequently used email address for the second person, one of the first or second identifiers, or any other identifier that references the second person in a manner that is understandable to the first person.

Another related aspect of identity aggregation is the generation of unique identifiers and/or containers for information about a particular user. For example, the PSN may provide a user with a machine-readable data block, such as a bar code (e.g., Quick Response bar code) that includes various information items relevant to the user, including links to their social networks, contact information, and the like.

One embodiment provides a method for aggregating identity information for one of a plurality of users that each belong to one or more social networking services, comprising: receiving a first identifier that identifies the one user on a first one of the social networking services; receiving a second identifier that identifies the one user on a second one of the social networking services; determining that the first and second identifiers both identify the one user; and transmitting a unified identifier for the one user, the unified identifier aggregating the first and second identifiers.

Feed & Status Update Aggregation

As noted above, the PSN may be configured to aggregate feed and status update information received from multiple social networking services or other sources.

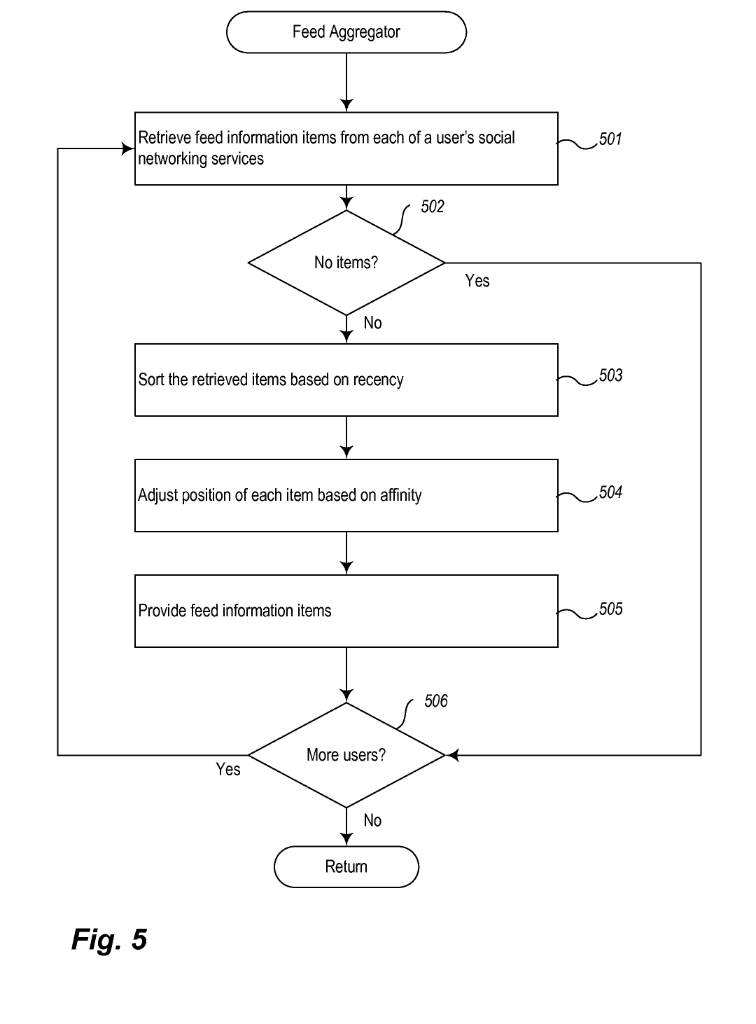

FIG. 5 is an example flow diagram of a feed aggregator process performed by an example embodiment of a proximity-based social networking facilitator system. The process may be performed by, for example, the feed and status update manager 111 described with reference to FIG. 1A. The process retrieves and aggregates feed information items from one or more social networks.

The process begins at block 501, where it retrieves feed information items from each of a current user's social networking services. As many users utilize more than one social networking service, retrieving feeds from each of these services is typically performed in parallel. Also, the process typically attempts to retrieve the most recent items, such as items posted within the last X hours (e.g., 24 hours). If no items are retrieved, the process may expand the retrieval window one or more times, such as by retrieving items posted in the last 48 hours.

A feed information item provides information about some other user, such as a user who is related to (e.g., is a friend of) the current user via a social network, or a user of some other information service (e.g., a picture sharing service, video sharing service). Typically, a feed information item can reflect or describe any action taken by a user on a social network or other system, such as posting a status update, adding a picture, playing a game, posting a comment, sharing a video, or the like. A feed information item may include text, image, audio, video, or other types of data, including interactive or executable content (e.g., program code).

In addition, retrieving feeds may include filtering out non-unique feeds. In some cases, redundant or duplicate feed information items may be obtained by the process. For example, a social networking service may organize feeds by friend and activity. In such cases, a feed item from a particular friend posting a picture of recent trip may appear under that friend's feeds, as well as a recent picture postings feed. When this occurs, the process may identify and remove the duplicate feed item. As another example, a user may post the same status update to multiple social networking services. Here, the process may determine that although two received feed information items are not identical (e.g., because they were received from different social networking services), they do have the same (or sufficiently similar) content, and thus can be represented as a single unique feed information item, either by removing one of them or coalescing/combining them into a single item.

At block 502, the process determines whether no items were retrieved, and if not, proceeds to block 503, else to block 506 to begin processing the next user. At block 503, the process sorts the retrieved items based on recency. Typically, the items are sorted in order of increasing age, so that more recent items appear prior to less recent items. Other criteria may be used to sort items instead of or in addition to age, including by name (e.g., topic), by user, by location, and the like.

At block 504, the process adjusts the position of each item of the retrieved items based on affinity. In one embodiment, adjusting the position of items based on affinity includes moving an item a number of positions up (or down) the order based on how many times the current user has expressed a like or dislike for the user that posted the item. Thus, as between items that would otherwise appear in the same position in the order, an item from a user that is liked by the current user will be made to appear prior to an item from a user that is disliked by the current user. Other explicit or implicit actions of the current user may be taken into account to determine a measure of affinity, including how frequently the current user has viewed another user's profile, communicated with another user, read another user's feed, made a proximity-based connection with another user, and the like.

At block 505, the process provides the ordered feed information items. Providing the ordered feed information items may include storing the items, such as for later retrieval by or transmission to the current user.

At block 506, the process determines whether there are more users to process, and if so, continues the loop of block 501-506, else returns. As described here, the illustrated process loops through the entire user community, retrieving and processing feed items for each user. The process may be executed at regular time intervals to regularly process feeds for the entire user community. In other embodiments, the process may preferentially process feeds for particular users, such as high-demand users who are particularly active in terms of viewing feed information items, or premium users who have paid an additional fee to receive higher frequency updates. In some embodiments, the process (or a similar one) may execute in an on-demand manner, such as in response to a user request to view feeds.

Some embodiments perform one or more operations/aspects in addition to, or instead of, the ones described with reference to the process of FIG. 5. In one embodiment, the illustrated process caches feed items received during prior executions, such that it can retrieve feed items using a smaller time window than described above. For example, if the process executes every hour, it may cache feed items retrieved during previous executions, such that during a current execution it needs only to retrieve feed items posted during the last hour.

Activity Aggregation

The PSN may be configured to perform multiple actions, operations, or activities on behalf of a user, in response to a single operation performed by the user. In some cases, the actions may be homogenous in type. For example, when a user posts a status update, the status update may be automatically forwarded by the PSN to multiple social networks. In other cases, the actions may be heterogeneous in type. For example, in response to receiving an indication that a user has expressed a preference for a media item, such as a song, the PSN causes a message (e.g., email, instant message, tweet) to be sent, causes the user to be added to a fan list for the song, and causes a status update to be posted to a social network used by the user. In at least some embodiments, the particular actions taken by the PSN can be configured by the user, such that the user can specify one or more actions to take in response to other actions initiated by the user. In other embodiments, the PSN learns actions to be taken in response to actions initiated by the user, based on user history.

### 5. Communication Techniques

The PSN facilitates communication via multiple distinct communication services, including voice, chat, instant message, email, and the like.

As one example, the PSN may provide a unified approach or interface to multiple chat or instant messaging services, thus alleviating problems typically faced by users, such as determining where or to which account to send an instant message, email, or other communication. In one embodiment, the PSN includes a messaging proxy that automatically and transparently determines the appropriate messaging service and/or client to use to deliver a destination message, based on user behavior and other factors. Various different types of messaging services are contemplated, including email services, social networking chat/message services, instant messenger services, text message (e.g., SMS, MMS), voice services (e.g., VOIP, voice message services), video services, or the like.

For example, assume that user A decides to send a message to user B, who is a user of the PSN and has messaging accounts B1 and B2 with services X and Y respectively. In sending a message to user B, user A is shielded from the complexities of the various messaging services and accounts associated with user B. Instead, user A is simply presented with a uniform messaging interface provided by the PSN (such as is described with respect to FIGS. 3T and 3U, above), and the PSN handles the complexities of delivering user A's message to the appropriate location. In particular, if user B is actively and currently using a messaging service provided by the PSN, then the PSN will deliver user A's message via that messaging service and using an interface such as the one described with respect to FIGS. 3T and 3U, above. If, on the other hand, user B is not currently active on the PSN, the PSN will determine the best one of accounts B1 or B2 to use as a destination for the message, based on which account is most recently or frequently used by user B.

In some embodiments, the PSN determines a fall-back or default messaging service to use for every user. The fall-back service may be determined based on user behavior (e.g., the most frequently used service, the most recently used service), user indication (e.g., an indication received from the user to send messages via a particular service), or the like. The fall-back messaging service may be used when no other messaging service appears to be more appropriate.

Note also that the described techniques may be performed across heterogeneous devices, such as mobile devices and desktop computers. For example, if the PSN determines that a recipient is currently using a desktop computer, a chat message may be automatically delivered to that computer rather than the mobile device of the user.

Also, in some cases, the PSN may provide a messaging client that provides a substantially uniform user experience across multiple different device types. For example, if the PSN determines that a recipient is currently accessing a social network via a desktop computer, the PSN can deliver a message via that social network to the recipient, the message including a link or other reference to a messaging client that is similar to a standard messaging client provided by the PSN (e.g., similar to that described with reference to Figured 3T and 3U), such that the user can have a uniform communication experience even though they are not currently actively accessing the PSN via a mobile device. When the user receives the message, they can initiate execution of the messaging client from within the context of their social network.

### 6. Proximity-Based Transaction Support

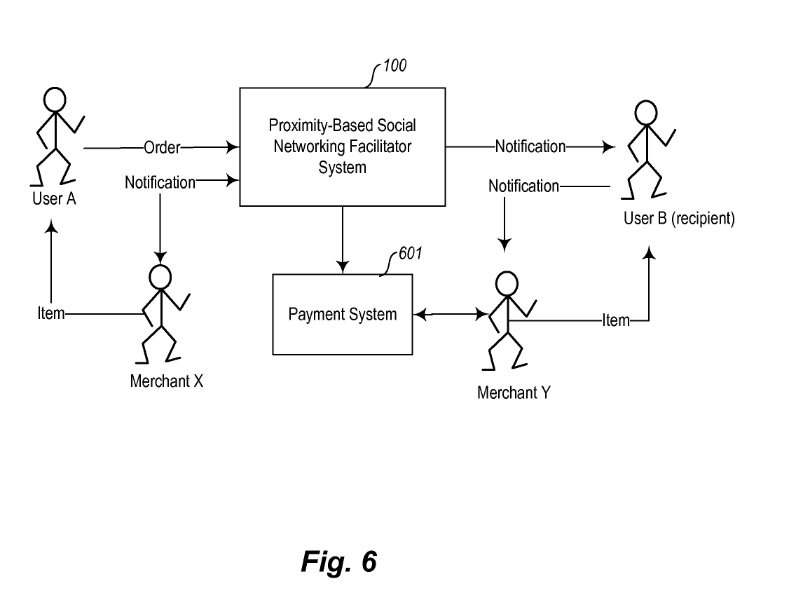

FIG. 6 is an example block diagram illustrating example transactions facilitated by an example embodiment of a proximity-based social networking facilitator system. In some embodiments, the PSN 100 facilitates transactions for goods and/or services, including the purchase of gifts, targeted advertising, product placement, money transfers (remittances), proximity-based purchase opportunities, verification and/or authentication, and the like.

As a first example transaction, the PSN 100 may facilitate a point-of-sale operation for a user and/or a merchant. For example, user A may enter into a café operated by merchant X and order a coffee via PSN 100. If merchant X is a user of the PSN 100, the PSN 100 may provide merchant X with a notification of the order, as well as information about (e.g., name and/or picture) of user A, such that merchant X can fulfill the order by providing the ordered coffee to user A. The PSN 100 can then credit an account associated with merchant X in the amount of the transaction, without recourse to a payment system (e.g., a credit card processing network) and thus avoid or reduce fees associated with use of such system. If merchant X is not a user of the PSN 100, other payment mechanisms are contemplated, as will be described below.

As a second example transaction, a user may purchase a gift or other item for another user. As shown in FIG. 6, user A may place an order for an item via the PSN 100. For example, when user A comes into proximity with (e.g., walks past) a restaurant operated by merchant Y, he may be automatically be presented (by the PSN 100) with a purchase opportunity, such as to buy a drink or meal for himself or another user. In response, user A purchases a drink for user B to be tendered by merchant Y. Later, when user B comes into proximity with the restaurant of merchant Y, the PSN 100 notifies him of the drink ordered by user A. In response, user B enters the restaurant and merchant Y fulfills the order by delivering the drink to user B. Note that the gift or order need not be attached to a specific merchant or location, and could instead be attached instead to user B, such that whenever user B comes into proximity with a merchant that can fulfill the order, the PSN 100 will notify user B of that fact.

Various fulfillment approaches are contemplated, based on whether merchant Y is or is not a user of PSN 100. If merchant Y is a user of PSN 100, PSN 100 can transmit the order notification directly to merchant Y, as discussed above with respect to the first example transaction. On the other hand, if merchant Y is not a user of PSN 100, at least two techniques may be utilized. In the first technique, the notification received by user B includes a payment card identifier (e.g., 16-digit credit/debit card number and associated information) that merchant Y can enter into a point of sale terminal that communicates with a payment system 601 in order to initiate a credit of merchant Y's account via a standard financial network transaction. The payment identifier may be provided as a string of credit card numbers, or in other ways, such as via a bar code (e.g., Quick Response bar code) that can be displayed on the user's device and scanned by the merchant. In the second technique, merchant Y has (or is provided with) a payment (e.g., credit/debit card) card associated with the PSN 100. As part of the notification, the PSN 100 places value “onto” the card (e.g., by crediting an account associated with the card), which merchant Y can then run through his point of sale terminal to initiate a payment to merchant Y's account via the payment system 601. In some embodiments, one incentive for merchant Y to establish an account with PSN 100 is that the standard charges (typically, for example, a 3% charge) applied to transactions over a financial credit card network may not apply, and the PSN 100 may be able to offer a competing payment service having lower cost overhead.

Note that the PSN 100 enables a late-binding, least commitment approach to order fulfillment. In particular, the PSN 100 provides a mechanism whereby a user can order an item for another user without having to specify various fulfillment details, such as a physical address for the recipient. Instead, user A can order a book for user B by knowing only a user identifier associated with user B (e.g., email address, social network user name, etc.). User A need not know or specify a mailing address for user B, because that information can be obtained from user B, depending on how user B elects to have the order fulfilled. For example, when user A buys a book for user B, user B receives a notification of the order that may provide various options for delivery, including pick up at a local store, shipping to an address provided by user B, or the like. Thus, purchase decisions are not delayed or otherwise inhibited because the purchasing user does not have sufficient information (e.g., an address to be used to reach a traveling recipient user) to place an order.

In a third example transaction, the PSN 100 can facilitate proximity-based purchase opportunities. For example, the PSN 100 learns of an event, such as a musical or concert occurring at a particular location. In response, the PSN 100 drops (e.g., places) a purchase opportunity for a music CD or other item related to the concert in proximity to the concert (e.g., around the concert hall or club). Then, when or after user A comes into proximity with the concert (e.g., attends the concert), user A is presented with the option to buy the CD. If user A wishes to buy the CD, they can complete the order with a single interaction with their mobile device, rather than having to wait until a suitable time and place to search for, order, and pay for the item.

In a fourth example transaction, the PSN 100 facilitates money transfers between users. For example, user A may wish to send $100 to user B. To do so, user A transfers $100 from his account on PSN 100 to user B. User B receives a notification along with a list of proximately located merchants who are able to remit the $100. User B then visits one of the merchants and receives the $100 from the merchant using one of the three fulfillment strategies discussed above. In the first, the merchant is a user of PSN 100 and can receive a transfer of $100 to their merchant account. In the second, the notification received by user B includes a payment identifier that can be entered by the merchant into a point of sale terminal coupled to the payment system 601 (e.g., a credit card network). In the third, the merchant has or is provided with a payment card that can be used in conjunction with a point of sale terminal to provide payment to the merchant via the payment system 601.

Note that although this money transfer example was explained by way of merchants, the remitting user may be any user who is willing to complete the transaction, thus providing a widely distributed network of localized remittance opportunities. Note also that the PSN 100 provides a lightweight approach to remittances that avoids using legacy financial transaction systems (e.g., wire transfer, international funds transfer) and incurring associated high transaction fees. Such transaction fees under current legacy systems may inhibit the ability to remit small amounts such as may often be done by a family member to others in his family.

The PSN 100 can also provide confirmation to a purchaser or transferor that a transaction has been completed. In one embodiment, a merchant who delivers or tenders an item or service takes a photo of the receiving user. The photo is time and geo-tagged by the PSN 100, such that the purchaser can be provided with a confirmation that a particular item, payment, or service was actually provided to the recipient (and not an interloper) at a particular location and time.

The PSN 100 can also provide identity verification to third parties. For example, the payment system 601 may utilize the PSN 100 to verify the identity of a user by generating a challenge question to the user. Because the PSN 100 has a record of user location and activity history, the PSN 100 has the ability to generate specific, time, location, or activity based questions that can only be answered correctly by an authentic user, such as questions asking a user where he was that morning, who he sent an email to last night, and the like. For example, when user A purchases an item from merchant X using a credit card, the payment system 601 may request PSN 100 to verify that user A is in fact in proximity to merchant X. In response, the PSN 100 determines the current location of user A, and provides a verification thereof to the payment system 601. In addition, or in the alternative, PSN 100 can request user A to answer a specific question, such as where that user was earlier that morning, to provide further assurance that user A is authentic.

The PSN 100 also provides for the reduction of transaction fees by enabling transaction consolidation. As one example, a merchant may perform many transactions using the PSN 100 over the course of a day, and at the end of the day initiate a single bulk transaction (for the sum of all transactions) with the payment system 601, such that the merchant is only charged a single transaction fee by the payment system 601.

In a fifth example transaction, the PSN 100 facilitates the delivery of a virtual gift from one user to another user. In this type of transaction, a user may select a virtual gift, such as an electronic greeting card, a song, a poem, an artwork, or the like. The virtual gift may be selected from a marketplace provided by the PSN 100. The gifts available in the marketplace may be provided by artists and other users, who share in revenue obtained when gifts are selected and delivered. In some embodiments, users may specify triggers or otherwise schedule the delivery of gifts, so that, for example, a greeting card will be timely transmitted for a recipient's birthday or other event.

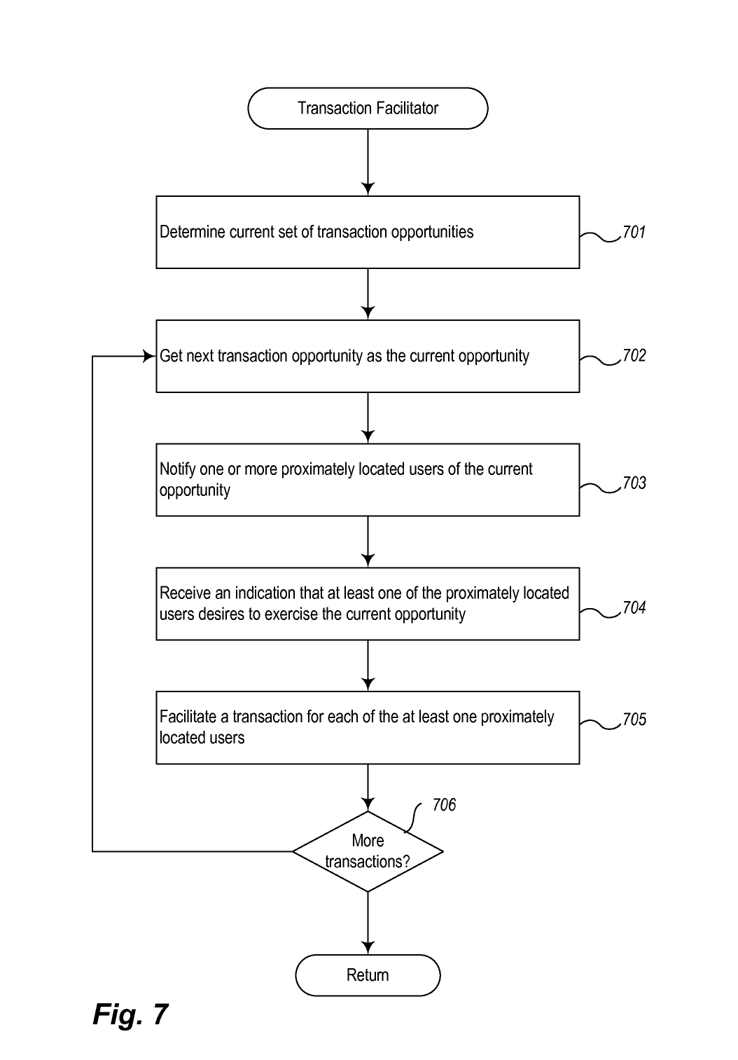

FIG. 7 is an example flow diagram of a transaction facilitator process performed by an example embodiment of a proximity-based social networking facilitator system. The process may be performed by, for example, the transaction manager 114 described with reference to FIG. 1A. The process facilitates proximity-based transactions.

The process begins at block 701, where it determines a current set of transaction opportunities. A transaction includes any exchange of value fora tangible or intangible good or service. A transaction opportunity includes a possibility to engage in a particular transaction, such as an offer to provide a good or a service at a particular price, discount (e.g., as in a coupon), place, and/or time. In some cases, transactions opportunities may be associated with one or more users, such as by being linked to a specific user, targeted to a class of users (e.g., females between the ages of 20 and 30), or the like.

Determining the current set of transaction opportunities may include receiving transaction opportunities from merchants or other users or systems. For example, a restaurant may provide the process with a transaction opportunity that includes an offer to sell a menu item at a particular price or discount to passersby of the restaurant. As another example, a user may purchase a gift for another user by providing the process with a transaction opportunity that includes an order for a particular item, possibly from a particular merchant or class of merchants (e.g., any merchant that can provide the item). Determining the current set of transaction opportunities may also include processing a data store that has recorded multiple transaction opportunities, such as ones that may have been previously provided by merchants or other users, and identifying those opportunities that are active during the current time period.

In blocks 702-706, the process performs a loop in which it iterates over the set of transaction opportunities, and facilitates transactions for those users who elect to engage in presented transaction opportunities. At block 702, the process gets the next transaction opportunity (of the current set of opportunities) as the current opportunity.

At block 703, the process notifies one or more proximately located users of the current opportunity. Notifying the proximately located users may include determining the proximately located users. As noted above, a transaction opportunity is typically associated with a particular location. Determining the proximately located users may include determining those users that are near the location of the opportunity (e.g., within a specified distance, in the specified retail location) and/or that match the opportunity for other reasons, such as being a target user of the opportunity.

Notifying the proximately located users may also include transmitting a message or other indication of the transaction opportunity, thereby causing client devices operated by the proximately located users to display details about the transaction opportunity. For example, a client device may display a message that describes an offer to purchase a good or service. In some cases, the message may be a menu, such as when a user enters a restaurant or coffee shop, so that the user can place an order without needing to wait for a waiter or waitress to become available.

At block 704, the process receives an indication that at least one of the proximately located users desires to exercise the current opportunity. Typically, a user will utilize his client device to accept an offer or other type of transaction that is part of the current opportunity. This causes a message or other indication to be transmitted from the client device to the process.

At block 705, the process facilitates a transaction for each of the at least one proximately located users. Facilitating the transaction may include processing a payment associated with the transaction, such as by transferring credits or other tokens of value from a user account with the PSN to a merchant account with the PSN. In other cases, such as when the merchant does not have an account with the PSN, facilitating the transaction may include initiating a payment via a third party payment system, such as a bank transfer, credit/debit card processor, or the like. As discussed above, in some cases payments may be batched up, such as by recording multiple payments to a single merchant, and then processing them via a single interaction with a third party payment systems, so as to avoid or reduce transaction costs associated with those payment systems.

At block 706, the process determines whether there are more transactions to process, and if so, continues the loop of blocks 702-706 to process additional transactions, else returns.

Some embodiments perform one or more operations/aspects in addition to, or instead of, the ones described with reference to the process of FIG. 7. In one embodiment, the illustrated process is structured as an event handler that responds to transaction related events, such as an indication that a new transaction opportunity has entered the system (e.g., received from a merchant), an indication that a user has come into proximity with a transaction opportunity, an indication that a user wishes to engage in a transaction opportunity, an indication that a merchant has requested payment, or the like. In addition, other types of transaction are contemplated, such as those described above, including but not limited to money transfers, coupons, offers for sale, offers to purchase, and the like. Also, the process may provide additional services, such as the identity verification and/or authentication services discussed above.

### 7. Example Architectures

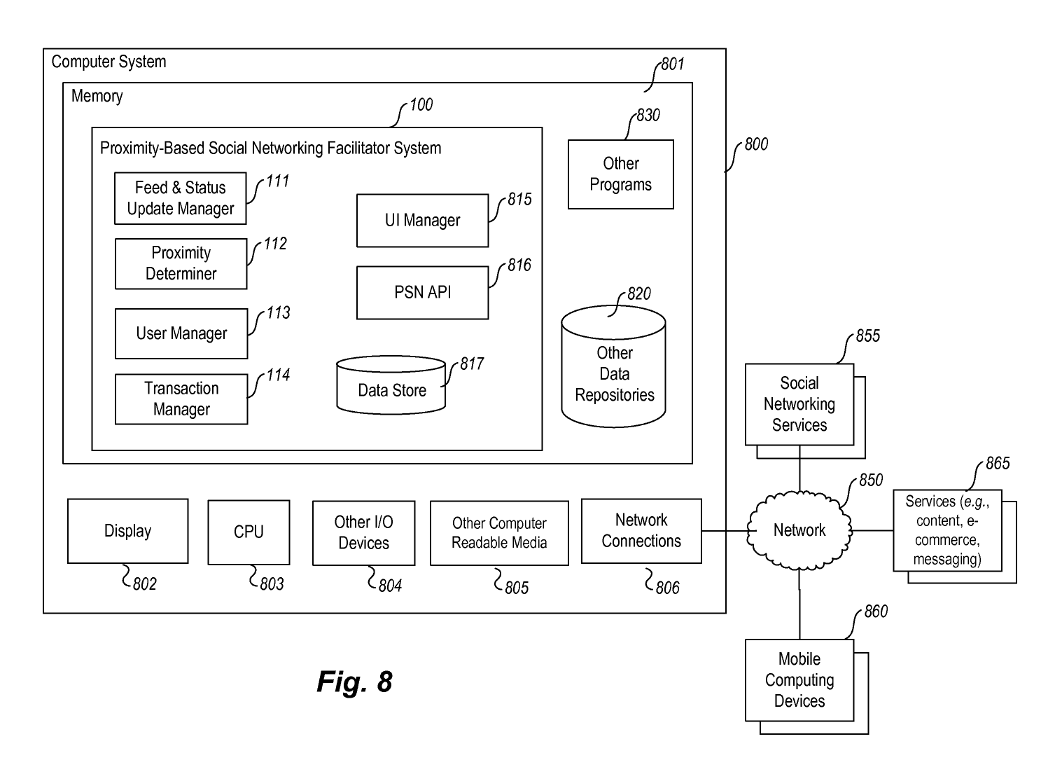

FIG. 8 is an example block diagram of an example computing system for implementing an example proximity-based social networking facilitator system according to an example embodiment. In particular, FIG. 8 shows a computing system 800 that may be utilized to implement a proximity-based social networking facilitator PSN 100.

Note that one or more general purpose or special purpose computing systems/devices may be used to implement the PSN 100. In addition, the computing system 800 may comprise one or more distinct computing systems/devices and may span distributed locations. Furthermore, each block shown may represent one or more such blocks as appropriate to a specific embodiment or may be combined with other blocks. Also, the PSN 100 may be implemented in software, hardware, firmware, or in some combination to achieve the capabilities described herein.

In the embodiment shown, computing system 800 comprises a computer memory (“memory”) 801, a display 802, one or more Central Processing Units (“CPU”) 804, Input/Output devices 804 (e.g., keyboard, mouse, CRT or LCD display, and the like), other computer-readable media 805, and network connections 806. The PSN 100 is shown residing in memory 801. In other embodiments, some portion of the contents, some or all of the components of the PSN 100 may be stored on and/or transmitted over the other computer-readable media 805. The components of the PSN 100 preferably execute on one or more CPUs 803 and facilitate proximity-based social networking, as described herein. Other code or programs 830 (e.g., an administrative interface, a Web server, and the like) and potentially other data repositories, such as data repository 820, also reside in the memory 801, and preferably execute on one or more CPUs 803. Of note, one or more of the components in FIG. 8 may not be present in any specific implementation. For example, some embodiments may not provide other computer readable media 805 or a display 802.

In a typical embodiment, the PSN 100 includes a feed and status update manager 111, a proximity determiner 112, a user manager 113, and a transaction manager 114, as described with respect to FIG. 1A. The PSN may also include a user interface manager 815, a PSN Application Program Interface (“API”) 816, and a data store 817.

The UI manager 815 provides a view and a controller that facilitate user interaction with the PSN 100 and its various components. For example, the UI manager 815 may provide interactive access to services of the PSN 100 for end users and/or administrative users. In some embodiments, access to the functionality of the UI manager 815 may be provided via a Web server, possibly executing as one of the other programs 830. In such embodiments, a user operating a Web browser executing on one of the mobile computing devices 860 (or some other system) as a client device can interact with the PSN 100 via the UI manager 815.

The API 816 provides programmatic access to one or more functions of the PSN 100. For example, the API 816 may provide a programmatic interface to one or more functions of the PSN 100 that may be invoked by one of the other programs 830 or some other module. In this manner, the API 816 facilitates the development of third-party software, such as user interfaces, plug-ins, news feeds, adapters (e.g., for integrating functions of the PSN 100 into other systems), and the like. In addition, the API 816 may be in at least some embodiments invoked or otherwise accessed via remote entities, such as one of the mobile computing devices 860, to access various functions of the PSN 100.

The data store 817 is used by the other modules of the PSN 100 to store and/or communicate information. Components of the PSN 100 (e.g., modules 111-114, 815, and/or 816) use the data store 817 to record various types of information, including user information, relationship information, feeds, status updates, geographic information, and the like. Although the components of the PSN 100 are described as communicating primarily through the data store 817, other communication mechanisms are contemplated, including message passing, function calls, pipes, sockets, shared memory, and the like.

The PSN 100 interacts via the network 850 with social networking services 855, other services 865, and mobile computing devices 860. The network 850 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The mobile computing devices 860 are client devices operated to interact with the PSN 100. An example mobile computing device is described further with reference to FIG. 9, next.

FIG. 9 is an example block diagram of an example mobile computing device for implementing an example proximity-based social networking client according to an example embodiment. In particular, FIG. 9 shows a mobile computing device 900 that may be utilized to implement a proximity-based social networking client 910 configured to interact with a PSN 100. The mobile computing device 900 are client devices operated to interact with the PSN 100 and include mobile phones, smart phones, palm top computers, laptop computers, and the like. In other embodiments, a user may utilize multiple devices that together form a client system that can interact with the PSN 100. For example, a user may have a vehicle based GPS system that can provide location information to a mobile computing device 910 that can in turn interact with the PSN 100.

Note that one or more general purpose or special purpose computing systems/devices may be used to implement the client 910. In addition, the mobile computing device 900 may comprise one or more distinct computing systems/devices and may span distributed locations. Furthermore, each block shown may represent one or more such blocks as appropriate to a specific embodiment or may be combined with other blocks. Also, the client 910 may be implemented in software, hardware, firmware, or in some combination to achieve the capabilities described herein.

In the embodiment shown, device 900 comprises a computer memory (“memory”) 901, a display 902, one or more Central Processing Units (“CPU”) 904, Input/Output devices 904 (e.g., keyboard, mouse, CRT or LCD display, and the like), other computer-readable media 905, and network connections 906. The IO devices 904 typically include a GPS receiver or other location information components that can be accessed to provide information regarding the location of the device 900. The client 910 is shown residing in memory 901. In other embodiments, some portion of the contents, some or all of the components of the client 910 may be stored on and/or transmitted over the other computer-readable media 905. The components of the client 910 preferably execute on one or more CPUs 903 and facilitate proximity-based social networking, as described herein. Other code or programs 930 (e.g., telephony code, a Web browser, and the like) and potentially other data repositories, such as data repository 920, also reside in the memory 901, and preferably execute on one or more CPUs 903. Of note, one or more of the components in FIG. 9 may not be present in any specific implementation. For example, some embodiments may not provide other computer readable media 905.

In a typical embodiment, the client 910 includes a location provider 911, a communication manager 912, a social network manager 913, a transaction manager 914, a user interface manager 915, and a client-side PSN Application Program Interface (“API”) 916, and a data store 917.

The location provider 911 obtains location information, such as from a GPS receiver of the device 900, and transmits such information to the PSN 100. In other embodiments, location information may be provided to the PSN 100 via other mechanisms, including from service or network providers directly to the PSN 100.

The communication manager 912 provides communication services, such as text messaging, instant messaging, voice services, and the like. In some embodiments, one or more of such services are provided by other components of the device, such as one of the other programs 930. For example, when the device 900 is a mobile phone, voice services may be provided as part of the phone operating system, firmware, and/or hardware.

The social network manager 913 manages information about the social networks of a user, in cooperation with the PSN 100. The social network manager 913 manages contact lists, relationship maps, feed information items, status updates, and the like. In some cases, the social network manager 913 primarily provides an interface to services provided by the PSN 100. In other cases, the functions may be distributed between the PSN 100 and the social network manager 913. For example, the PSN 100 may obtain and transmit feed information to the manager 913, which then aggregates those items as discussed above.

The transaction manager 914 facilitates transactions performed by or in cooperation with PSN 100. For example, the transaction manager 914 may manage order information, payment information, or the like. In addition, the transaction manager 914 may monitor and notify the user of transaction opportunities.

The UI manager 915 provides a view and a controller that facilitate user interaction with the client 910 and its various components. For example, the UI manager 915 may provide interactive access to services of the client 910, such as by providing screens such as those discussed with respect to FIGS. 3A-3U.

The API 916 provides programmatic access to one or more functions of the client 910. For example, the API 916 may provide a programmatic interface to one or more functions of the client 910 that may be invoked by one of the other programs 930 or some other module. In this manner, the API 916 facilitates the development of third-party software, such as user interfaces, plug-ins, news feeds, adapters (e.g., for integrating functions of the client 910 into other programs or systems), and the like. In addition, the API 916 may be in at least some embodiments invoked or otherwise accessed via remote entities, such as to transmit (e.g., push) data (e.g., feed information items, status updates, messages) from the PSN 100 to the client device 910.

The data store 917 is used by the other modules of the client 910 to store and/or communicate information. Components of the client 910 (e.g., modules 911-916) use the data store 817 to record various types of information, including user information, relationship information, feeds, status updates, geographic information, and the like. Although the components of the client 910 are described as communicating primarily through the data store 917, other communication mechanisms are contemplated, including message passing, function calls, pipes, sockets, shared memory, and the like.

The client 910 interacts via the network 850 with social networking services 855, other services 865, the PSN 100, and other mobile computing devices 860 (FIG. 8).

In an example embodiment, components/modules of the PSN 100 and/or the client 910 are implemented using standard programming techniques. For example, the PSN 100 and/or the client 910 may be implemented as a “native” executable running on the CPUs 803 or 903, along with one or more static or dynamic libraries. In other embodiments, the PSN 100 and/or the client 910 may be implemented as instructions processed by a virtual machine that executes as one of the other programs 830 or 930. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the PSN 100 and/or the client 910, such as in the data stores 817 and 917, can be available by standard mechanisms such as through C, C++, C#, and Java APIs; libraries for accessing files, databases, or other data repositories; through scripting languages such as XML; or through Web servers, FTP servers, or other types of servers providing access to stored data. The data stores 817 and 917 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the PSN 100 and/or the client 910 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and/or data structures may be stored as non-transitory content on one or more tangible computer-readable mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

One embodiment provides a method in a computing system, comprising: providing a proximity-based social networking environment to a plurality of users that are each operating a mobile device, the plurality of users each belonging to one or more social networking services, by: receiving location information from each of the mobile devices; determining a subset of the plurality of users, each of the users of the subset being proximately located to every other user of the subset and having indicated a desire to be made electronically visible to other users; and causing the mobile devices operated by each of the subset of users to present, without use of a map or any other specific indication of a user location, information about other users of the subset.

In some embodiments, the presented information includes identity information about one or more of the users of the subset. In some embodiments, the presented information includes a user name of each of one or more of the users of the subset.

In some embodiments, the method further comprises: facilitating a face to face meeting between two users of the determined subset of users. In some embodiments, facilitating the face to face meeting includes receiving a meeting request from a first one of the two users, forwarding the meeting request to a second one of the two users, receiving an acceptance from the second one of the two users, and forwarding the acceptance to the first one of the two users.

In some embodiments, the method further comprises: aggregating identity information for one of the plurality of users, by: receiving a first identifier that identifies the one user on a first one of the social networking services; receiving a second identifier that identifiers the one user on a second one of the social networking services; determining that the first and second identifiers both identify the one user; and transmitting a unified identifier for the one user, the unified identifier aggregating the first and second identifiers.

In some embodiments, determining that the first and second identifiers both identify the one user includes registering the one user and receiving from the one user credentials for accessing the first and second social networking services, the credentials including the first and second identifiers. In some embodiments, transmitting the unified identifier includes transmitting a directory and/or contact list of user information. In some embodiments, transmitting the unified identifier includes transmitting as the unified identifier at least one of: a given name for the one user, a family name for the one user, the first identifier, and/or the second identifier.

In some embodiments, the method further comprises: aggregating feed information items including status updates from the users of the subset; and causing the mobile devices operated by each of the subset of the users to present the aggregated feed information items. In some embodiments, the aggregating feed information items includes ordering the feed information items based on at least one of: an age of each of the feed information items; whether one of the users of the subset has indicated whether the one user desires to view more or fewer feed information items from another user of the subset; whether one of the users of the subset has indicated whether the one user likes another user of the subset; and a behavioral history of one of the users, including how often the one user has communicated with another user of the subset, how often the one user has viewed a profile of another user of the subset, common interests between two or more users of the subset, and/or common demographic factors of two or more users of the subset.

In some embodiments, the aggregating feed information items includes receiving feed information items posted during a specified time period. In some embodiments, the aggregating feed information items includes receiving an indication of an action taken by a user on the social network, the action including at least one of: posting a status update, adding a picture, adding a video, posting a comment, and/or sharing a media item. In some embodiments, the aggregating feed information items includes receiving feed information items that include at least one of: text, audio, video, image, and/or interactive content. In some embodiments, the aggregating feed information items includes filtering out non-unique feed information items. In some embodiments, the aggregating feed information items includes transmitting a group of feed information items that include feed information items obtained from at least two social networking services. In some embodiments, the aggregating feed information items includes aggregating feed information items from at least one social networking service and at least one media sharing service.

In some embodiments, the method further comprises: receiving, via one of the social networks, a status update posted to the one social network by one of the users from the subset; forwarding the status update to other social networks; and causing the mobile devices operated by each of the subset of the users to present the aggregated status updates.

In some embodiments, the method further comprises: performing multiple heterogeneous actions in response to a single indication received from a user, the multiple heterogeneous actions including at least two of: sending an email message, sending a text message, posting a status update, indicating a like or dislike for a person or thing, and/or adding a user to a follower list.

In some embodiments, the method further comprises: generating a social map for a user by aggregating information obtained from at least two distinct social networking services, the social map including indications of users that are related to the user via at least one of the two social networking services. In some embodiments, the generating the social map includes aggregating information obtained from a secondary network that is at least one of: an email list, a newsgroup, an online forum, an address book, a fan list, and/or a company. In some embodiments, the generating the social map includes aggregating information obtained from a list of conference attendees. In some embodiments, the generating the social map includes aggregating information from a list of frequently called persons obtained from a telecom provider.

In some embodiments, the method further comprises: providing a social analytics service that is configured to assist a user in understanding and maintaining relationships with other persons. In some embodiments, the providing the social analytics service includes causing the mobile device operated by one of the plurality of users to present statistics about relationships of the user. In some embodiments, the providing the social analytics service includes causing the mobile device operated by one of the plurality of users to present an ordered view of relationships of the user, the view ordered by at least one of: frequency of communication, gender, age, and/or relationship type. In some embodiments, the providing the social analytics service includes receiving an indication of a friendship that the user wishes to develop further, and in response, suggesting an action to be taken by the user to strengthen the friendship, the action including at least one of: sending a birthday greeting, sending an anniversary greeting, initiating a communication on a regular basis, and/or posting a comment on a status update.

In some embodiments, the receiving location information includes receiving location information provided to one of the mobile devices by a GPS receiver in the mobile device. In some embodiments, the receiving location information includes receiving location at substantially regular time intervals from one of the mobile devices. In some embodiments, the receiving location information includes receiving location information with a frequency that increases when one of the mobile devices is moving and that decreases when the one mobile device is stationary.

In some embodiments, the method further comprises: persisting a location for one of the mobile devices. In some embodiments, the persisting the location occurs in response to a passage of time during which no location information is received from the mobile device. In some embodiments, the persisting the location occurs in response to a received indication that the mobile device will remain substantially at the received location for a specified time period. In some embodiments, the persisting the location includes determining a likely location, based at least in part on the previously received location information from the mobile device. In some embodiments, the persisting the location includes determining a likely location, based at least in part on a location history based on multiple location indications previously received from the mobile device.

In some embodiments, the method further comprises: generating a location history for one of the users, the location history based on multiple location indications received from the mobile device operated by the user over multiple days. In some embodiments, the method further comprises: predicting, based on the location history, a location for the user at a future time; determining a destination that is at or near the predicted location; and transmitting a message to the mobile device operated by the user, the message including a suggestion that the user visit the determined destination. In some embodiments, the destination is at least one of: a bar, a theater, a club, a restaurant, a library, a sporting venue, a music venue, and/or a park. In some embodiments, the method further comprises: generating a location history for each of at least some of the users, the location histories based on multiple location indications received from the mobile devices operated by the at least some users over multiple days; determining, based on the generated location histories, two of the at least some users who are compatible for a carpool; and notifying each of the two users that a possible carpool arrangement exists with the other of the two users.

In some embodiments, the method further comprises: receiving an indication that one of the users is traveling to another city; determining that the one user has arrived in the other city; determining one or more users who are located in the other city and who are related to the one user via one or more of the social networking services; and notifying the one or more users that the one user has arrived in the other city.

In some embodiments, the determining the subset of users includes determining a subset of users that are related to one another via at least one of: one or more of the social networking services; a secondary network that is at least one of: an email list, a newsgroup, an online forum, an address book, a fan list, and/or a company; and/or an ad-hoc group that is at least one of: a list of conference attendees, invitees to a social event, performance attendees. In some embodiments, the determining the subset of users that are related to one another includes determining users who are directly related to one another via one of the social networks. In some embodiments, the determining the subset of users that are related to one another includes determining users who are indirectly related to one another via one or more of the social networks, wherein at least some of the users are friends of friends of other of the users. In some embodiments, the determining the subset of users that are related to one another includes determining that a first user is related to a second user by determining that the first user is related to a third user via a first social networking service, and determining that the second user is related to the third user via a second social networking service.

In some embodiments, the method further comprises: receiving an indication of a visibility level from one of the users, the visibility level specifying that the user wishes to share information with at least one of: friends and/or friends of friends.

In some embodiments, the method further comprises: receiving an indication that one of the users wishes their visibility to remain private; and in response to the received indication, not transmitting any information about the location of the one user to any other users; and not providing any information about the location of any other users to the one user.

In some embodiments, the method further comprises: receiving an indication of a profile from one of the users, the profile indicating one or more other users that the one user wishes to share location information with; and transmitting information about the one user to those users of the profile that are proximately located to the one user. In some embodiments, the profile is a work-related profile and includes users who are professionally related to the one user. In some embodiments, the profile is a social profile and includes users who are socially related to the one user.

In some embodiments, the determining the subset of users includes determining users that are located within a predetermined distance of each other.

In some embodiments, the method further comprises: representing a metropolitan area as multiple spaces that each represent a bounded portion of the area and that each include an indication of a cost associated with traveling through or to the space, the cost based on at least one of: geographic factors, topographic factors, topological factors, demographic factors, and/or sociological factors. In some embodiments, representing the metropolitan region as multiple spaces includes associating with each of the spaces an indication of an affinity of a user for the space, the affinity based on at least one of how many times the user has visited the space, destinations located in the space that the user is likely interested in, and/or a number of friends of the user that reside or work in the space. In some embodiments, the determining the subset of users includes determining travel costs for each of the subset of users based on which of the multiple spaces each user is located in and based on each user's respective affinity for one or more of the multiple spaces.

In some embodiments, the method further comprises: receiving an indication of a media object dropped at a location by one of the users; determining one or more of the users that are proximately located to media object and that are related to the one user; and transmitting an indication of the media object to the one or more users. In some embodiments, the media object is at least one of: a picture, an audio file, a video, and/or a message.

In some embodiments, the method further comprises: receiving multiple media objects that each have an associated location and an associated user; and generating a location history for the associated user based on the associated locations of the multiple media objects. In some embodiments, the multiple media objects are each at least one of: an image, an audio file, a video, a text object.

In some embodiments, the method further comprises: registering a new user by requesting credentials for one of the social networking services and without requesting creation of a new user name and password.

One embodiment provides a second method in a computing system, comprising: facilitating proximity-based transactions for a plurality of users that are each operating a mobile device, by: receiving an order for a good or service, the order specifying a recipient user; and fulfilling the order based on a proximity-based interaction between a recipient user and a merchant. In some embodiments, the second method is performed as further actions to the first method.

In some embodiments, the first and/or second method further comprises: placing a purchase opportunity in proximity to one of the users. In some embodiments, the second method further comprises: associating a purchase opportunity with a location; when a user comes into proximity with the location, presenting the user with the purchase opportunity. In some embodiments, the location is a food service establishment, and the method further comprises: receiving an order for an item provided by the food service establishment; and transmitting the order to the food service establishment, such that the user can order an item without interacting with an order taking person in the food service establishment. In some embodiments, the purchase opportunity includes indications of multiple menu items.

In some embodiments, the order is to transfer money from one user to another user. In some embodiments, fulfilling the order includes receiving an indication that a recipient user is in proximity to a merchant that can provide the good or service.

In some embodiments, the first and/or second method further comprises: notifying a recipient user of the order, based on the proximity of the recipient user to a merchant. In some embodiments, the notifying the recipient user includes providing the recipient user with a payment card identifier that can be entered by the merchant into a point of sale terminal to initiate payment to the merchant for the good or service.

In some embodiments, the first and/or second method further comprises: associating, with one of the users, an order of a gift for the one user; when the one user comes into proximity with a merchant that can fulfill the order for the gift, presenting the one user with a notification that the gift is available via the merchant. In some embodiments, the order for the gift is an order for a drink.

One embodiment provides a computing system configured to facilitate proximity based social networking, comprising: a memory; a module stored on the memory that is configured, when executed, to perform a method according to one or more of the above-described methods.

In some embodiments, the module includes software instructions for execution in the memory of the computing system. In some embodiments, the module is a proximity-based social networking facilitator.

One embodiment provides a computer-readable medium whose contents, when executed, cause a computing system to facilitate proximity-based social networking, by performing a method according to one or more of the above-described methods.

In some embodiments, the computer-readable medium is at least one of a memory in a computing device or a data transmission medium transmitting a generated signal containing the contents. In some embodiments, the contents are instructions that, when executed, cause the computing system to perform the method.

One embodiment provides a method in a client device, comprising: facilitating proximity-based social networking with a plurality of users each belonging to one or more social networking services, by: transmitting location information to a remote proximity-based social networking system; transmitting to the remote system an indication that a user operating the client device wishes to share information about himself with other users; receiving from the remote system an indication of one or more users who are proximately located to the user; and presenting, without use of a map or any other specific indication of a user location, information about the one or more users.

In some embodiments, the method in the client device further comprises: receiving an indication that the user no longer wishes to share information about himself with other users; disabling presentation of information about any proximately located users.

In some embodiments, each of the one or more users is related to the users via at least one of: one or more of the social networks; a secondary network that is at least one of: an email list, a newsgroup, an online forum, an address book, a fan list, and/or a company; and/or an ad-hoc group that is at least one of: a list of conference attendees, invitees to a social event, performance attendees.

In some embodiments, at least one of the one or more users is indirectly related to the user via a second user, the second user directly related to the user via a first social network, and the second user directly related to the at least one user via a second social network.

In some embodiments, the method in the client device further comprises: receiving from the remote system aggregated feed information items from multiple social networking services, each feed information item associated with a user; and presenting at least some of the received feed information items in a single list, the presented items ordered based on the user's affinity for the user associated with the feed information item.

In some embodiments, the method in the client device further comprises: receiving from the remote system a suggestion to travel to a destination, based on a predicted future location for the user and/or affinity of the user for the destination; and presenting the suggestion.

In some embodiments, the method in the client device further comprises: receiving an indication of a profile that specifies one or more users with whom to share information about the user; presenting only information about users who are one of the one or more users specified by the profile. In some embodiments, the profile is a social profile or a work-related profile.

In some embodiments, the method in the client device further comprises: receiving an indication to be invisible for a specified time period; and during the specified time period, not presenting any information about other users who are proximately located to the user; and after the specified time period, presenting information about other users who are proximately located to the user.

In some embodiments, the method in the client device further comprises: facilitating a face to face meeting with another user who is proximately located to the user by transmitting a meeting request to the other user, the meeting request including a suggested time and/or place to meet.

In some embodiments, the method in the client device further comprises: facilitating a proximity-based transaction for a good or service. In some embodiments, facilitating the transaction includes receiving a notification of a transaction opportunity at a proximately located merchant. In some embodiments, the method in the client device further comprises: presenting an indication of the transaction opportunity; receiving an indication that the operating user wishes to engage in the transaction; and transmitting transaction information identifying a good or service being purchased.

One embodiment provides a second client device configured to facilitate proximity based social networking, comprising: a memory; a location information provider module; a module stored on the memory that is configured, when executed, to perform a method according to one or more of the above-described methods and/or to interact with a server-side social networking system that performs one or more of the above-described methods.

In some embodiments, the module of the second client device includes software instructions for execution in the memory of the client device. In some embodiments, the client device is a smart phone.

One embodiment provides a computer-readable medium whose contents, when executed, cause a client device to facilitate proximity-based social networking, by performing a method according to one or more of the above-described methods and/or to interact with a server-side social networking system that performs one or more of the above-described methods.

In some embodiments, the computer-readable medium is at least one of a memory in the client device or a data transmission medium transmitting a generated signal containing the contents. In some embodiments, the contents are instructions that, when executed, cause the client device to perform the method.

One embodiment provides a third method in a computing system, comprising: providing a proximity-based social networking environment to a plurality of users that are each operating a mobile device, the plurality of users each belonging to one or more social networking services, by: receiving location information from each of the mobile devices; determining a subset of the plurality of users, each of the users of the subset being proximately located to every other user of the subset and having indicated a desire to be made visible to other users; and causing the mobile devices operated by each of the subset of users to present information about other users of the subset.

In some embodiments, the causing the mobile devices to present information about the other users of the subset includes presenting indications of locations of the users on a map.

In some embodiments, the third method further comprises: performing operations of one or more of the above methods.

One embodiment provides a method in a client device, comprising: facilitating proximity-based social networking with a plurality of users each belonging to one or more social networking services, by: transmitting location information to a remote proximity-based social networking system; transmitting to the remote system an indication that a user operating the client device wishes to share information about himself with other users; receiving from the remote system an indication of one or more users who are proximately located to the user; and presenting information about the one or more users.

In some embodiments, the presenting the information includes presenting indications of locations of the users on a map.

In some embodiments, the method in the client device further comprises: performing operations of one or more of the above methods and/or interacting with a server-side social networking system that performs one or more of the above methods.

One embodiment provides a proximity based social networking server as described by any one of FIGS. 1-9 or above text.

One embodiment provides a proximity based social networking client as described by any one of FIGS. 1-9 or above text.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/317,165, filed on Mar. 24, 2010, entitled “SYSTEMS AND METHODS FOR PROXIMITY-BASED SOCIAL NETWORKING;” U.S. Provisional Patent Application No. 61/317,615, filed on Mar. 25, 2010, entitled “SYSTEMS AND METHODS FOR PROXIMITY-BASED TRANSACTIONS;” U.S. Provisional Patent Application No. 61/318,678, filed on Mar. 29, 2010, entitled “OBJECT-ORIENTED FRAMEWORK FOR FACILITATING PROXIMITY-BASED INTERACTIONS;” and U.S. Provisional Patent Application No. 61/348,098, filed on May 25, 2010, entitled “SYSTEMS AND METHODS FOR PROXIMITY-BASED SOCIAL NETWORKING” are incorporated herein by reference, in their entireties.

From the foregoing it will be appreciated that, although specific embodiments have been described herein for purposes of illustration, various modifications may be made without deviating from the spirit and scope of the invention. For example, the methods, systems, and techniques for performing proximity-based social networking discussed herein are applicable to other architectures other than a social-networking architecture. For example, the techniques can be used without specific social networking information, but with other indicia of affinity, including user behaviors and the like. Also, the methods, systems, and techniques discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, cellphones, other mobile devices, etc.).

1. A method in a computing system, comprising:
providing a proximity-based social networking environment to a plurality of users that are each operating a mobile device, the plurality of users each belonging to one or more social networking services, by:
receiving location information from each of the mobile devices;
determining a subset of the plurality of users, each of the users of the subset being proximately located to every other user of the subset and having indicated a desire to be made visible electronically to other users; and
causing the mobile devices operated by each of the subset of users to present, without use of a map or any other specific indication of a user location, information about other users of the subset.

2. The method of claim 1 wherein the presented information includes identity information about one or more of the users of the subset.

3. The method of claim 1, further comprising:
facilitating a face to face meeting between two users of the determined subset of users by receiving a meeting request from a first one of the two users, forwarding the meeting request to a second one of the two users, receiving an acceptance from the second one of the two users, and forwarding the acceptance to the first one of the two users.

4. The method of claim 1, further comprising:
aggregating identity information for one of the plurality of users, by:
receiving a first identifier that identifies the one user on a first one of the social networking services;
receiving a second identifier that identifies the one user on a second one of the social networking services;
determining that the first and second identifiers both identify the one user; and
transmitting a unified identifier for the one user, the unified identifier aggregating the first and second identifiers.

5. The method of claim 4 wherein determining that the first and second identifiers both identify the one user includes receiving from the one user credentials for accessing the first and second social networking services, the credentials including the first and second identifiers.

6. The method of claim 1, further comprising:
aggregating feed information items including status updates from the users of the subset; and
causing the mobile devices operated by each of the subset of the users to present the aggregated feed information items.

7. The method of claim 6 wherein the aggregating feed information items includes ordering the feed information items based on at least one of:
an age of each of the feed information items;
whether one of the users of the subset has indicated whether the one user desires to view more or fewer feed information items from another user of the subset;
whether one of the users of the subset has indicated whether the one user likes another user of the subset; and
a behavioral history of one of the users, including how often the one user has communicated with another user of the subset, how often the one user has viewed a profile of another user of the subset, common interests between two or more users of the subset, and/or common demographic factors of two or more users of the subset.

8. The method of claim 1, further comprising:
receiving an indication of a media object dropped at a location by one of the users;
determining one or more of the users that are proximately located to media object and that are related to the one user; and
transmitting an indication of the media object to the one or more users.

9. The method of claim 8 wherein the media object is at least one of: a picture, an audio file, a video, and/or a message.

10. The method of claim 1, further comprising:
receiving multiple media objects that each have an associated location and an associated user; and
generating a location history for the associated user based on the associated locations of the multiple media objects.

11. The method of claim 10 wherein the multiple media objects are each at least one of: an image, an audio file, a video, a text object.

12. The method of claim 1, further comprising:
facilitating proximity-based transactions for the plurality of users, by:
receiving an order for a good or service from one of the mobile devices, the order specifying a recipient user; and
fulfilling the order based on a proximity-based interaction between a recipient user and a merchant.

13. The method of claim 12, further comprising:
associating a purchase opportunity with a location;
when a user comes into proximity with the location, presenting the user with the purchase opportunity on the mobile device operated by the user.

14. The method of claim 13 wherein the location is a food service establishment, and further comprising:
receiving an order for an item provided by the food service establishment; and
transmitting the order to the food service establishment, such that the user can order an item without interacting with an order taking person in the food service establishment.

15. The method of claim 12 wherein the order is to transfer money from one user to another user.

16. The method of claim 12 wherein fulfilling the order includes receiving an indication that a recipient user is in proximity to a merchant that can provide the good or service.

17. The method of claim 12, further comprising:
notifying a recipient user of the order, based on the proximity of the recipient user to a merchant.

18. The method of claim 12, further comprising:
associating, with one of the users, an order of a gift for the one user;
when the one user comes into proximity with a merchant that can fulfill the order for the gift, presenting the one user with a notification that the gift is available via the merchant.

19. A computing system configured to facilitate proximity based social networking, comprising:
a memory;
a module stored on the memory that is configured, when executed, to:
provide a proximity-based social networking environment to a plurality of users that are each operating a mobile device, the plurality of users each belonging to one or more social networking services, by:
receiving location information from each of the mobile devices;
determining a subset of the plurality of users, each of the users of the subset being proximately located to every other user of the subset and having indicated a desire to be made visible to other users; and
causing the mobile devices operated by each of the subset of users to present, without use of a map or any other specific indication of a user location, information about other users of the subset.

20. A computer-readable medium whose contents, when executed, cause a computing system to facilitate proximity-based social networking, by:
providing a proximity-based social networking environment to a plurality of users that are each operating a mobile device, the plurality of users each belonging to one or more social networking services, by:
receiving location information from each of the mobile devices;
determining a subset of the plurality of users, each of the users of the subset being proximately located to every other user of the subset and having indicated a desire to be made visible to other users; and
causing the mobile devices operated by each of the subset of users to present, without use of a map or any other specific indication of a user location, information about other users of the subset.
